(19) United States
(12) Patent Application Publication
(10) Pub. No.: US 2025/0060866 A1
(43) Pub. Date: Feb. 20, 2025

(54) GESTURE-BASED LOAD CONTROL

(71) Applicant: Lutron Technology Company LLC, Coopersburg, PA (US)

(72) Inventor: Curtis R. Aaron, Philadelphia, PA (US)

(73) Assignee: Lutron Technology Company LLC, Coopersburg, PA (US)

(21) Appl. No.: 18/721,028

(22) PCT Filed: Dec. 17, 2022
(86) PCT No.: PCT/US2022/053272

§ 371 Date: Jun. 17, 2024

Related U.S. Application Data
(60) Provisional application No. 63/265,666, filed on Dec. 17, 2021.

(51) Int. Cl. G06F 3/04842; E06B 9/32; G06F 3/04817; G06F 3/0488; G06F 3/16; H05B 47/175

(52) U.S. Cl. CPC G06F 3/04842; E06B 9/32; G06F 3/04817; G06F 3/0488; G06F 3/165; H05B 47/1975

(57) ABSTRACT

A load control device may be controlled via a gesture performed by a user on a display of a mobile device. For example, the intensity level and/or the state of an electrical load controlled by the load control device may be controlled via gesture. The gesture may be a press and drag gesture. The mobile device may receive an actuation of an icon representing the load control device for at least a predetermined amount of time, and may enter a load control mode. The mobile device may detect a movement of the actuation and may determine an updated intensity level or state for the load control device based on the direction of the movement, the amount of the movement, and/or the endpoint of the movement. The mobile device may transmit one or more messages to the load control device comprising instructions configured to control the load control device.

### CROSS-REFERENCE TO RELATED APPLICATIONS

This application claims the benefit of U.S. Provisional Patent Application No. 63/265,666, filed Dec. 17, 2021, the disclosure of which is incorporated herein by reference in its entirety.

### BACKGROUND

A user environment, such as a residence, an office building, or a hotel for example, may be configured to include various types of load control systems. For example, a lighting control system may be used to control one or more control devices in the user environment. The control devices may include, for example, one or more light control devices, motorized window treatments, thermostats, speakers, ceiling fans, and/or the like. Each control device may be associated with one or more control parameters. For example, the control parameters may include an intensity level, a color temperature, a color output, a vibrancy level, a temperature, a shade position, etc. For a given control device, each control parameter associated with that control device may be set to a given value (e.g., setting). For example, a lighting control device may be associated with an intensity, which may be measured on a relative scale from 0% (e.g., fully off/dimmed) to 100% (e.g., fully on).

One or more of the load control devices in the load control system may be controlled via an application (e.g., control software) running on a mobile device (e.g., a mobile device). For example, a user of the mobile device may use the control software to control the intensity, color temperature, color output, vibrancy level, temperature, and/or shade position of a given load control device. Each load control device may be associated with one or more load control modes (e.g., screens, windows, etc.) which may be used to control the load control device.

### SUMMARY

As described herein, one or more load control devices may be controlled using control software. For example, the respective intensities of electrical loads controlled by the load control devices may be controlled using the control software. The load control devices may be controlled using one or more load control modes. In a first load control mode, the control software may display information about a selected load control device, and the intensity of the electrical load controlled by the load control device may be controlled via a slider. In a second load control mode, the intensity of the electrical load controlled by the load control device may be controlled via a user gesture on a display of the mobile device. For example, the user may actuate an icon representing the load control device on the display of the mobile device for at least a predetermined amount of time, and then may gesture in an upward direction to increase the intensity of the electrical load controlled by the load control device, or in a downward direction to decrease the intensity of the electrical load controlled by the load control device. The user may gesture in an upward direction to turn the electrical load controlled by the of the load control device on, or in a downward direction to turn the electrical load controlled by the load control device off. The control software may display (e.g., overlay) a status bar or an on/off indication to indicate that the load control device is being controlled.

The above advantages and features are of representative embodiments only. They are not to be considered limitations. Additional features and advantages of embodiments will become apparent in the following description, from the drawings, and from the claims.

### BRIEF DESCRIPTION OF THE DRAWINGS

FIG. 1A is a diagram of an example load control system.

FIG. 1B is a block diagram illustrating an example of a device capable of processing and/or communication in the load control system of FIG. 1A.

FIG. 1C is a block diagram illustrating an example load control device.

FIGS. 2A-2B show example graphical user interfaces of an application that may allow a user to determine information on and to control a load control system and/or control devices.

FIGS. 2C-2G show further example graphical user interfaces of an application that may allow a user to control a load control system and/or control devices.

FIGS. 3A-3B show further example graphical user interfaces of an application that may allow a user to control a load control system and/or control devices.

FIG. 4 is an example flowchart for controlling the intensity level of a load control device via user actuation of an icon on a display of a mobile device.

FIG. 5 is another example flowchart for controlling the intensity level of a load control device via user actuation of an icon on a display of a mobile device.

FIG. 6 is an example flowchart for controlling the state of an electrical load being controlled by a load control device via user actuation of an icon on a display of a mobile device.

FIG. 7 is another example flowchart for controlling the state of an electrical load being controlled by a load control device via user actuation of an icon on a display of a mobile device.

FIG. 8 is an example flowchart for controlling a load control device via user actuation of an icon on a display of a mobile device.

FIG. 9 is yet another example flowchart for controlling the intensity level of a load control device via user actuation of an icon on a display of a mobile device.

### DETAILED DESCRIPTION

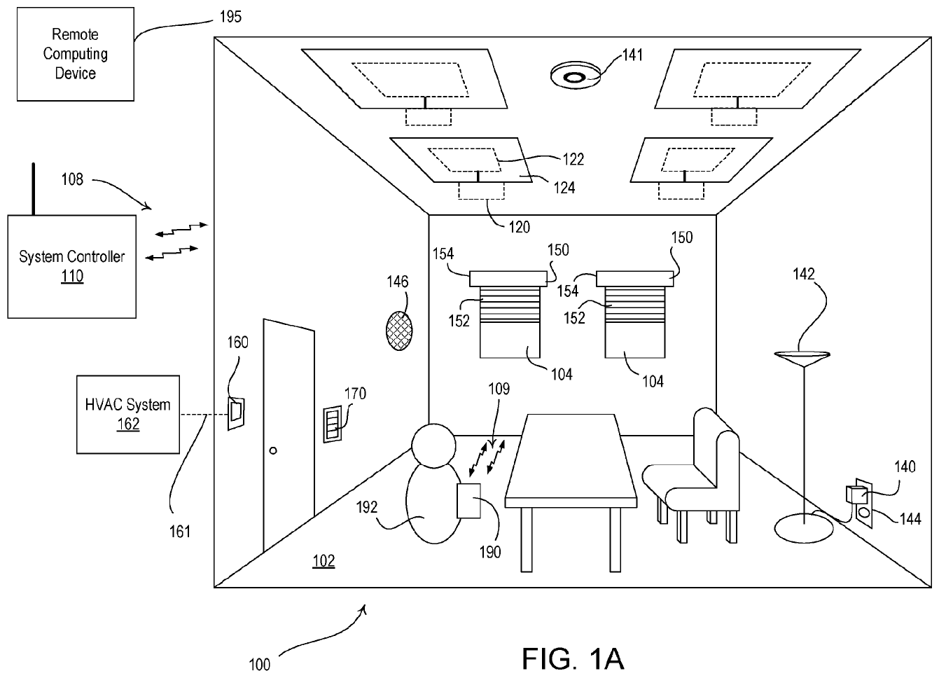

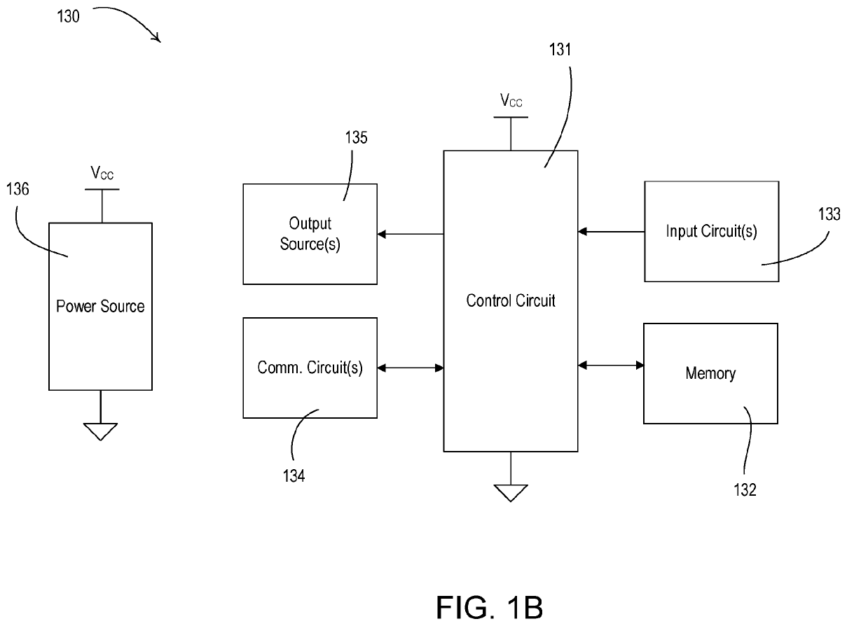

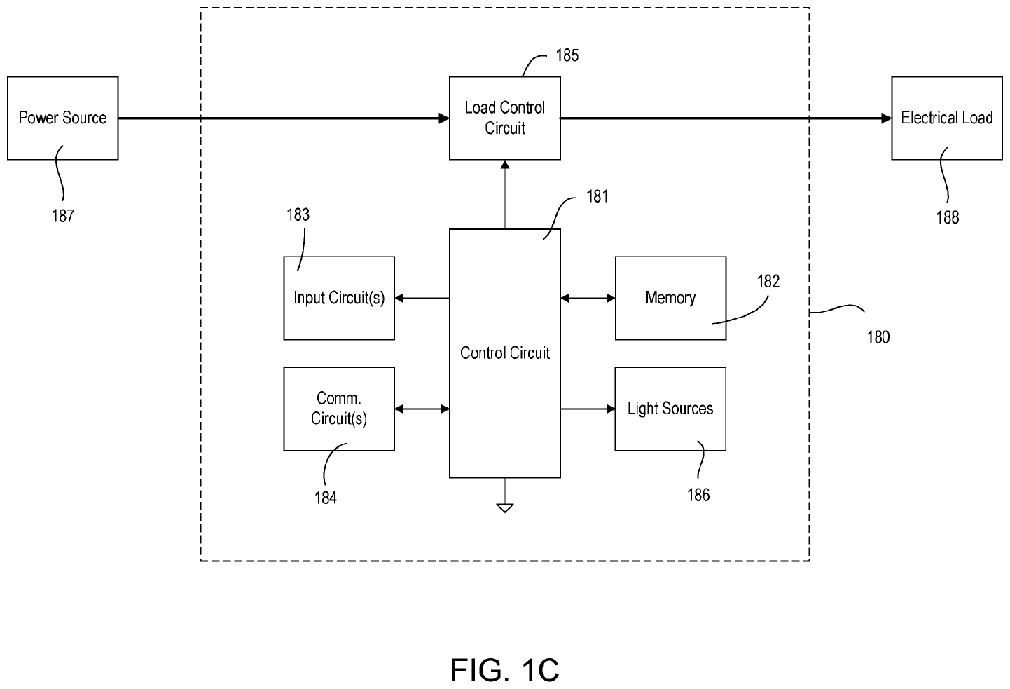

FIG. 1A is a diagram of an example load control system 100 for controlling the amount of power delivered from an alternating-current (AC) power source (not shown) to one or more electrical loads. The load control system 100 may be installed in a load control environment 102. The load control environment 102 may include a space in a residential or commercial building. For example, the load control system 100 may be installed in one or more rooms on one or more floors in the building.

The load control system 100 may comprise a plurality of control devices. The control devices may include load control devices that are configured to control one or more electrical loads in the load control environment 102 (also referred to as a user environment). For example, the load control devices may control the one or more electrical loads in response to input from one or more input devices or other devices in the load control system 100.

The load control devices in the load control system 100 may include lighting control devices. For example, the load control system 100 may include lighting control devices 120 for controlling lighting loads 122 in a corresponding lighting fixture 124. The lighting control devices 120 may comprise light-emitting diode (LED) drivers and the lighting loads 122 may comprise LED light sources. While each lighting fixture 124 is shown having a single lighting load 122, each lighting fixture may comprise one or more individual light sources (e.g., lamps and/or LED emitters) that may be controlled individually and/or in unison by the respective lighting control device. Though an LED driver is provided as an example lighting control device, other types of lighting control devices may be implemented as load control devices in the load control system 100. For example, the load control system 100 may comprise dimmer switches, electronic dimming ballasts for controlling fluorescent lamps, or other lighting control devices for controlling corresponding lighting loads. The lighting control device 120 may be configured to directly control an amount of power provided to the lighting load 122. The lighting control device 120 may be configured to receive (e.g., via wired or wireless communications) messages via radio-frequency (RF) signals 108, 109 and to control the lighting load 122 in response to the received messages. One will recognize that lighting control device 120 and lighting load 122 may be integral and thus part of the same fixture or bulb, for example, or may be separate.

The lighting load 122 may be controlled by the lighting control device 120 to illuminate a color (e.g., color temperature or a full-color value) in response to messages that are received from devices in the load control system 100. The lighting control device 120 may control the lighting load 122 to a color value of a total light output of the emitted light produced by the lighting load 122. Each lighting load 122 may include a plurality of different colored LEDs. In other words, the lighting loads 122 may include a number of differently colored emission LEDs within a single package. The package may be configured such that the chromaticity output of the LEDs is mixed to produce light having varying chromaticity coordinates (e.g., color points) within a color gamut formed by the various LEDs that make up the lighting load 122. As one example, the lighting loads 122 may include one or more red LEDs, one or more green LEDs, one or more blue LEDs, and one or more white LEDs (which may be collectively referred to herein as an RGBW lighting load). White LEDs may comprise substantially white LEDs (e.g., phosphor-coated yellow and/or mint green LED(s)). Although the RGBW lighting load is described herein with a combination of four LEDs of certain colors, other combinations of LEDs (e.g., more or less LEDs and/or different color LEDs) may be used. For example, another combination of four or more LEDs of other color combinations may be used.

The lighting control devices 120 may adjust various settings of the corresponding lighting loads 122 to adjust the light emitted from the lighting loads. For example, the lighting control device 120 may adjust the intensity level (e.g., lighting intensity level and/or brightness), the color (e.g., correlated color temperature (CCT) value and/or full-color value), the value of a vibrancy parameter affecting color saturation, and/or another lighting control parameter. Each lighting control device 120 and respective lighting load 122 may be configured to produce white or near-white light of varying brightness/intensity within a range of color temperatures ranging from “warm white” (e.g., roughly 2600 Kelvin (K)-3700 K), to “neutral white” (e.g., 3700 K-5000 K) to “cool white” (e.g., 5000 K-8300 K). For example, the lighting control device 120 and respective lighting load 122 may be configured to produce light at colors of varying chromaticity coordinates that lie on or near the black body locus or curve. As a further example, the lighting control devices 120 and their corresponding light loads 122 may be further configured to produce any of a plurality of colors within the color gamut formed by the various LEDs that make up the lighting load 122.

Each lighting control device 120 and its respective lighting load 122 may be configured to increase and/or decrease a color saturation of objects in the load control environment 102. For example, the lighting control device 120 may control or be responsive to a vibrancy parameter that is configured to adjust a spectrum of the light emitted by the lighting load 122 in order to control the color saturation of the objects in the load control environment 102. The vibrancy parameter may allow the lighting control device 120 to tune the individual colors that make light at a given color (e.g., full color or a color temperature). The vibrancy parameter may allow the lighting control device 120 to control the saturation of light having given chromaticity coordinates. The vibrancy parameter allows the lighting control device 120 to control the power provided to the LEDs of the corresponding lighting loads 122 to adjust the overall spectral power distribution of the light source, which may affect the color of the light (e.g., the reflected light) on objects within the load control environment 102. Increases and decreases in the value of the vibrancy parameter may increase and/or decrease the color saturation of objects in the area without changing the color of the light emitted by the lighting loads 122 when the occupant of the space looks directly at the lighting loads 122. In an example, the vibrancy parameter may be a value between zero and one hundred percent for increasing and/or decreasing the color saturation of the objects in the load control environment 102. Changing the value of the vibrancy parameter may cause the lighting control device 120 to decrease or increase the intensity of one or more white LEDs (e.g., white or substantially white LEDs) that make up the respective lighting loads 122. For example, increasing the value of the vibrancy parameter may thereby decrease the intensity of the one or more white LEDs that make up the respective lighting loads 122, and thereby increase the color saturation of the objects in the load control environment 102. Decreasing the value of the vibrancy parameter may thereby increase the intensity of the one or more white LEDs that make up the respective lighting loads 122, and thereby decrease the color saturation of the objects in the load control environment 102. Changing the value of the vibrancy parameter in this manner may also include changing the intensities of other LEDs (e.g., red, green, and/or blue LEDs) of the lighting loads 122 to maintain the same color output and/or intensity level of the lighting loads 122 (e.g., to maintain the same (or approximately the same within one or more MacAdam ellipses) chromaticity coordinates of the mixed color output of the lighting loads) and/or the same lumen output of the lighting loads 122. Adjusting the vibrancy value may, however, adjust a spectral power distribution of the light, which may adjust the light reflected off of objects in the space. For example, as the vibrancy value increases, a spectral power distribution curve (e.g., spectrum) of the emitted light (e.g., relative intensity vs wavelength) may become sharper and/or may result in individual colors on the objects to appear more vibrant when the light reflects off of them. One example of such a lighting control device and respective lighting load is described as illumination device 38 of U.S. Pat. No. 10,237,945, issued Mar. 19, 2019, entitled ILLUMINATION DEVICE, SYSTEM AND METHOD FOR MANUALLY ADJUSTING AUTOMATED PERIODIC CHANGES IN EMULATION OUTPUT, the contents of which are hereby incorporated by reference in their entirety. One will recognize that other examples of lighting control devices and respective lighting loads are possible.

The load control devices in the load control system 100 may comprise one or more appliances that are able to receive the RF signals 108,109 (e.g., wireless signals) for performing load control. In an example, the load control system may include a speaker 146 (e.g., part of an audio/visual or intercom system), which is able to generate audible sounds, such as alarms, music, intercom functionality, etc. in response to RF signals 108, 109.

The load control devices in the load control system 100 may comprise one or more daylight control devices, e.g., motorized window treatments 150, such as motorized cellular shades, for controlling the amount of daylight entering the load control environment 102. Each motorized window treatment 150 may comprise a window treatment fabric 152 hanging from a headrail 154 in front of a respective window 104. Each motorized window treatment 150 may further comprise a motor drive unit (not shown) located inside of the headrail 154 for raising and lowering the window treatment fabric 152 for controlling the amount of daylight entering the load control environment 102. The motor drive units of the motorized window treatments 150 may be configured to receive messages via the RF signals 108 and adjust the position of the respective window treatment fabric 152 in response to the received messages. For example, the motorized window treatments may be battery-powered. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Examples of battery-powered motorized window treatments are described in greater detail in U.S. Pat. No. 8,950,461, issued Feb. 10, 2015, entitled MOTORIZED WINDOW TREATMENT, and U.S. Pat. No. 9,488,000, issued Nov. 8, 2016, entitled INTEGRATED ACCESSIBLE BATTERY COMPARTMENT FOR MOTORIZED WINDOW TREATMENT, the entire disclosures of which are hereby incorporated by reference.

The load control devices in the load control system 100 may comprise a plug-in load control device 140 for controlling a plug-in electrical load, e.g., a plug-in lighting load (such as a floor lamp 142 or a table lamp) and/or an appliance (such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108, 109 and to turn on and off or adjust the intensity of the floor lamp 142 in response to the received messages.

The load control devices in the load control system 100 may comprise one or more temperature control devices, e.g., a thermostat 160 for controlling a room temperature in the load control environment 102. The thermostat 160 may be coupled to a heating, ventilation, and air conditioning (HVAC) system 162 via a control link 161 (e.g., an analog control link or a wired digital communication link). The thermostat 160 may be configured to wirelessly communicate messages with a controller of the HVAC system 162. The thermostat 160 may comprise a temperature sensor for measuring the room temperature of the load control environment 102 and may control the HVAC system 162 to adjust the temperature in the room to a setpoint temperature. The load control system 100 may comprise one or more wireless temperature sensors (not shown) located in the load control environment 102 for measuring the room temperatures. The HVAC system 162 may be configured to turn a compressor on and off for cooling the load control environment 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the load control environment 102. The thermostat 160 may be configured to receive messages via the RF signals 108, 109 and adjust heating, ventilation, and cooling in response to the received messages.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, controllable circuit breaker, or other switching device for turning an appliance on and off, a controllable electrical receptacle, or controllable power strip for controlling one or more plug-in loads; a motor control unit for controlling a motor load, such as a ceiling fan or an exhaust fan; a drive unit for controlling a projection screen; motorized interior or exterior shutters; a thermostat for a heating and/or cooling system; a temperature control device for controlling a setpoint temperature of an HVAC system; an air conditioner; a compressor; an electric baseboard heater controller; a controllable damper; a variable air volume controller; a fresh air intake controller; a ventilation controller; a hydraulic valves for use radiators and radiant heating system; a humidity control unit; a humidifier; a dehumidifier; a water heater; a boiler controller; a pool pump; a refrigerator; a freezer; a television or computer monitor; a video camera; an audio system or amplifier; an elevator; a power supply; a generator; an electric charger, such as an electric vehicle charger; and/or an alternative energy controller.

The load control system 100 may comprise one or more input devices capable of receiving an input event for controlling one or more load control devices in the load control system 100. The input devices and the load control devices may be collectively referred to as control devices in the load control system 100. The input devices in the load control system 100 may comprise one or more remote control devices, such as a remote control device 170. The remote control device may be battery-powered. The remote control device 170 may be configured to transmit messages via RF signals 108 to one or more other devices in the load control system 100 in response to an input event, such as an actuation of one or more buttons or a rotation of a rotary knob of the remote control device 170. For example, the remote control device 170 may transmit messages to the lighting control device 120, the plug-in load control device 140, the motorized window treatments 150, and/or the temperature control device 160 via the RF signals 108 in response to actuation of one or more buttons located thereon. The message may include control instructions and/or an indication of the actuation of one or more buttons for controlling a load control device in the load control system 100. The remote control device 170 may also communicate with other devices in the load control system 100 via a wired communication link. In response to an input event at the remote control device 170, a devices to which the remote control device 170 is wired may be triggered to transmit messages to one or more other devices in the load control system 100. The remote control device 170 may comprise a keypad. In another example, the remote control device 170 may comprise a rotary knob configured to transmit messages to one or more other devices in response to a rotation on the rotary knob (e.g., rotation of a predefined distance or for a predefined period of time). The remote control device 170 may be mounted to a structure, such as a wall, a toggle actuator of a mechanical switch, or a pedestal to be located on a horizontal surface. In another example, the remote control device 170 may be handheld. The remote control device 170 may provide feedback (e.g., visual feedback) to a user of the remote control device 170 on a visual indicator, such as a status indicator. The status indicator may be illuminated by one or more light emitting diodes (LEDs) for providing feedback. The status indicator may provide different types of feedback. The feedback may include feedback indicating actuations by a user or other user interface event, a status of electrical loads being controlled by the remote control device 170, and/or a status of the load control devices being controlled by the remote control device 170. The feedback may be displayed in response to user interface event and/or in response to messages received that indicate the status of load control devices and/or electrical loads. Examples of battery-powered remote control devices are described in greater detail in commonly-assigned U.S. Pat. No. 8,330,638, issued Dec. 11, 2012, entitled WIRELESS BATTERY-POWERED REMOTE CONTROL HAVING MULTIPLE MOUNTING MEANS, and U.S. Patent Application Publication No. 2012/0286940, published Nov. 15, 2012, entitled CONTROL DEVICE HAVING A NIGHTLIGHT, the entire disclosures of which are hereby incorporated by reference.

The input devices of the load control system 100 may comprise one or more sensor devices, such as a sensor device 141. The sensor device 141 may be configured to transmit messages via the RF signals 108 to one or more other devices in the load control system 100 in response to an input event, such as a sensor measurement event. The sensor device 141 may also or alternatively be configured to transmit messages via a wired communication link to one or more other devices in the load control system 100 in response to an input event, such as a sensor measurement event. The sensor device 141 may operate as an ambient light sensor or a daylight sensor and may be capable of performing a sensor measurement event by measuring a total light intensity in the space around the sensor device 141. The sensor device 141 may transmit messages including the measured light level or control instructions generated in response to the measured light level via the RF signals 108. Examples of RF load control systems having daylight sensors are described in greater detail in commonly assigned U.S. Pat. No. 8,410,706, issued Apr. 2, 2013, entitled METHOD OF CALIBRATING A DAYLIGHT SENSOR; and U.S. Pat. No. 8,451,116, issued May 28, 2013, entitled WIRELESS BATTERY POWERED DAYLIGHT SENSOR, the entire disclosures of which are hereby incorporated by reference.

The sensor device 141 may operate as an occupancy sensor configured to detect occupancy and/or vacancy conditions in the load control environment 102. The sensor device 141 may be capable of performing the sensor measurement event by measuring an occupancy condition or a vacancy condition in response to occupancy or vacancy, respectively, of the load control environment 102 by the user 192. For example, the sensor device 141 may comprise an infrared (IR) sensor capable of detecting the occupancy condition or the vacancy condition in response to the presence or absence, respectively, of the user 192. The sensor device 141 may transmit messages including the occupancy conditions or vacancy conditions, or control instructions generated in response to the occupancy/vacancy conditions, via the RF signals 108. Again, the sensor device 141 may also or alternatively transmit messages including the occupancy conditions or vacancy conditions, or control instructions generated in response to the occupancy/vacancy conditions via a wired communication link. Examples of load control systems having occupancy and vacancy sensors are described in greater detail in commonly-assigned U.S. Pat. No. 8,228,184, issued Jul. 24, 2012, entitled BATTERY-POWERED OCCUPANCY SENSOR, U.S. Pat. No. 8,009,042, issued Aug. 30, 2011 Sep. 3, 2008, entitled RADIO-FREQUENCY LIGHTING CONTROL SYSTEM WITH OCCUPANCY SENSING, and U.S. Pat. No. 8,199,010, issued Jun. 12, 2012, entitled METHOD AND APPARATUS FOR. CONFIGURING A WIRELESS SENSOR, the entire disclosures of which are hereby incorporated by reference.

The sensor device 141 may operate as a visible light sensor (e.g., including a camera or other device capable of sensing visible light). The sensor device 141 may be capable of performing the sensor measurement event by measuring an amount of visible light within the load control environment 102. For example, the sensor device 141 may comprise a visible light sensing circuit having an image recording circuit, such as a camera, and an image processing circuit. The image processing circuit may comprise a digital signal processor (DSP), a microprocessor, a programmable logic device (PLD), a microcontroller, an application specific integrated circuit (ASIC), a field-programmable gate array (FPGA), or any suitable processing device capable of processing images or levels of visible light. The sensor device 141 may be positioned towards the load control environment 102 to sense one or more environmental characteristics in the load control environment 102. The image recording circuit of the sensor device 141 may be configured to capture or record an image. The image recording circuit of the sensor device 141 may provide the captured image to the image processor. The image processor may be configured to process the image into one or more sensed signals that are representative of the sensed environmental characteristics. The sensed environmental characteristics may be interpreted from the sensed signals by the control circuit of the sensor device 141 or the sensed signals may be transmitted to one or more other devices via the RF signals 108, 109 (e.g., a computing device in the load control environment) for interpreting the sensed environmental characteristics. For example, the sensed environmental characteristics interpreted from the sensed signals may comprise an occurrence of movement, an amount of movement, a direction of movement, a velocity of movement, a counted number of occupants, an occupancy condition, a vacancy condition, a light intensity, a color of visible light, a color temperature of visible light, an amount of direct sunlight penetration, or another environmental characteristic in the load control environment 102. In another example, the sensor device 141 may provide a raw image or a processed (e.g., preprocessed) image to one or more other devices (e.g., computing devices) in the load control system 100 for further processing. The sensor device 141 may operate as a color temperature sensor when sensing the color temperature of the visible light. Examples of load control systems having visible light sensors are described in greater detail in commonly-assigned U.S. Pat. No. 10,264,651, issued Apr. 16, 2019, entitled LOAD CONTROL SYSTEM HAVING A VISIBLE LIGHT SENSOR, and U S. Patent App. Pub. No. 2018/0167547, published Jun. 14, 2018, entitled CONFIGURATION OF A VISIBLE LIGHT SENSOR, the entire disclosures of which are hereby incorporated by reference.

The sensor device 141 may be external to the lighting fixtures 124 (e.g., affixed or attached to a ceiling or a wall of the load control environment 102). The sensor device 141 may be positioned towards the load control environment 102 and may be capable of performing sensor measurement events in the load control environment 102. In one example, the sensor device 141 may be affixed or attached to a window 104 of the load control environment 102 and operate as a window sensor that is capable performing sensor measurement events on light that is entering the load control environment 102 through the window 104. For example, the sensor device 141 may comprise an ambient light sensor capable of detecting when sunlight is directly shining into the sensor device 141, is reflected onto the sensor device 141, and/or is blocked by external means, such as clouds or a building based on the measured light levels being received by the sensor device 141 from outside the window. The sensor device 141 may send messages indicating the measured light level. Though illustrated as being external to the lighting fixtures 124, one or more sensor devices 141 may be mounted to one or more of the lighting fixtures 124 (e.g., on a lower or outward-facing surface of the lighting fixture 124). For example, one or more sensor devices 141 may be electrically coupled to a control circuit or a load control circuit of the load control devices 120 for performing control in response to the sensor measurement events of the sensor devices 141.

The load control system 100 may comprise other types of input devices, such as, for example, temperature sensors, humidity sensors, radiometers, cloudy-day sensors, shadow sensors, pressure sensors, smoke detectors, carbon monoxide detectors, air-quality sensors, motion sensors, security sensors, proximity sensors, fixture sensors, partition sensors, keypads, multi-zone control units, slider control units, kinetic or solar-powered remote controls, key fobs, cell phones, smart phones, tablets, personal digital assistants, personal computers, laptops, timeclocks, audio-visual controls, safety devices, power monitoring devices (e.g., such as power meters, energy meters, utility submeters, utility rate meters, etc.), central control transmitters, residential, commercial, or industrial controllers, and/or any combination thereof.

The input devices and the load control devices may be configured to communicate messages between one another on a communication link within the load control system 100. The communication link between control devices in the load control system may comprise one or more network communication links through which messages may be transmitted for performing end-to-end communications in the load control system 100. For example, the input devices and the load control devices may be capable of communicating messages directly to one another via the RF signals 108. The RF signals 108 may be transmitted using a proprietary RF protocol, such as the CLEAR CONNECT protocol (e.g., CLEAR CONNECT TYPE A and/or CLEAR CONNECT TYPE X protocols) and/or a standard protocol, for example, one of WIFI, BLUETOOTH, BLUETOOTH LOW ENERGY (BLE), ZIGBEE, Z-WAVE, THREAD protocols, for a different protocol. In an example, the input devices may transmit messages to the load control devices via the RF signals 108 that comprise input events (e.g., button presses, sensor measurement events, or other input event) or control instructions generated in response to the input events for performing control of the electrical loads controlled by the load control devices. The input devices and the load control devices may be configured to communicate via the RF signals 108 on a first wireless communication link via a first wireless communication protocol (e.g., a wireless network communication protocol, such as THREAD, CLEAR CONNECT TYPE A, CLEAR CONNECT TYPE X, WIFI, etc.) and communicate via the RF signals 109 on a second wireless communication link via a second wireless communication protocol (e.g., a short-range wireless communication protocol, such as BLUETOOTH, BLE, etc.). Though communication links may be described as a wireless communication links, wired communication links may similarly be implemented for enabling communications herein.

For devices in the load control system 100 to recognize messages directed to the device and/or to which to be responsive, the devices may be associated with one another by performing an association procedure. For example, for a load control device to be responsive to messages from an input device, the input device may first be associated with the load control device. As one example of an association procedure, devices may be put in an association mode for sharing a unique identifier for being associated with and/or stored at other devices in the load control system 100. For example, an input device and a load control device may be put in an association mode by the user 192 actuating a button on the input device and/or the load control device. The actuation of the button on the input device and/or the load control device may place the input device and/or the load control device in the association mode for being associated with one another. In the association mode, the input device may transmit an association message(s) to the load control device (directly or through one or more other devices as described herein). The association message from the input device may include a unique identifier of the input device. The load control device may locally store the unique identifier of the input device in association information, such that the load control device may be capable of recognizing messages (e.g., subsequent messages) from the input device that may include load control instructions or commands. The association information stored at the load control device may include the unique identifiers of the devices with which the load control device is associated. The load control device may be configured to respond to the messages from the associated input device by controlling a corresponding electrical load according to the load control instructions received in the messages. The input device may also store the unique identifier of the load control device with which it is being associated in association information stored locally thereon. A similar association procedure may be performed between other devices in the load control system 100 to enable each device to perform communication of messages with associated devices. This is merely one example of how devices may communicate and be associated with one another and other examples are possible.

According to another example, one or more devices may receive system configuration data (e.g., or subsequent updates to the system configuration data) that is uploaded to the devices and that specifies the association information comprising the unique identifiers of the devices for being associated. The system configuration data may comprise a load control dataset that defines the devices and operational settings of the load control system 100. The system configuration data may include information about the devices in the user environment 102 and/or the load control system 100, including configuration identifiers (e.g., fixture identifiers or load control device identifiers, groups, zones, areas, and/or location identifiers) of the control devices. For example, the system configuration data may include association information that indicates defined associations between devices in the load control system 100. The association information may be updated using any of the association procedures described herein.

One or more intermediary devices may also maintain association information that includes the unique identifiers that make up the associations of other devices in the load control system 100. For example, the input devices and the load control devices may communicate on a communication link in the load control system 100 through one or more other intermediary devices, such as router devices or other devices in a network. The intermediary devices may comprise input devices, load control devices, a central processing device, or another intermediary device capable of enabling communication between devices in the load control system. The association information that is maintained on the intermediary devices may comprise the unique identifiers of the devices that are associated with one another for identifying and/or enabling communication of messages between devices in the load control system 100. For example, an intermediary device may identify the unique identifiers being transmitted in association messages between devices during the association procedure and store the unique identifiers of the devices as an association in the association information. The intermediary devices may use the association information for monitoring and/or routing communications on a communication link between devices in the load control system 100. In another example, the association information of other devices may be uploaded to the intermediary device and/or communicated from the intermediary device to the other devices for being locally stored thereon (e.g., at the input devices and/or load control devices).

The load control system 100 may comprise a system controller 110. The system controller 100 may operate as an intermediary device, as described herein. For example, the system controller 110 may operate as a central processing device for one or more other devices in the load control system 100. The system controller 110 may operable to communicate messages to and from the control devices (e.g., the input devices and the load control devices). For example, the system controller 110 may be configured to receive messages from the input devices and transmit messages to the load control devices in response to the messages received from the input devices. The system controller 110 may route the messages based on the association information stored thereon. The input devices, the load control devices, and the system controller 110 may be configured to transmit and receive the RF signals 108 and/or over a wired communication link. The system controller 110 may be coupled to one or more networks, such as a wireless or wired local area network (LAN), e.g., for access to the Internet. The system controller 110 may be wirelessly connected to the networks using one or more wireless protocols. The system controller 110 may be coupled to the networks via a wired communication link, such as a network communication bus (e.g., an Ethernet communication link).

The system controller 110 may be configured to communicate via the network with one or more computing devices, e.g., a mobile device 190, such as a personal computing device and/or a wearable wireless device, and/or a remote computing device 195 (e.g., a server). The mobile device 190 may be located on an occupant 192, for example, may be attached to the occupant's body or clothing or may be held by the occupant. The mobile device 190 may be characterized by a unique identifier (e.g., a serial number or address stored in memory) that uniquely identifies the mobile device 190 and thus the occupant 192. Examples of personal computing devices may include a smart phone, a laptop, and/or a tablet device. Examples of wearable wireless devices may include an activity tracking device, a smart watch, smart clothing, and/or smart glasses. In addition, the system controller 110 may be configured to communicate via the network with one or more other control systems (e.g., a building management system, a security system, etc.).

The mobile device 190 may be configured to transmit messages to the system controller 110, for example, in one or more Internet Protocol packets. For example, the mobile device 190 may be configured to transmit messages to the system controller 110 over the LAN and/or via the Internet. The mobile device 190 may be configured to transmit messages over the Internet to an external service, and then the messages may be received by the system controller 110. The mobile device 190 may transmit and receive RF signals 109. The RF signals 109 may be the same signal type and/or transmitted using the same protocol as the RF signals 108. Alternatively, or additionally, the mobile device 190 may be configured to transmit RF signals according to another signal type and/or protocol. The mobile device 190 and/or the system controller 110 may be capable of communicating on communication links with other devices via RF signals 108, 109.

The load control system 100 may comprise other types of computing devices coupled to the network, such as a desktop personal computer (PC), a wireless-communication-capable television, or any other suitable Internet-Protocol-enabled device. Examples of load control systems operable to communicate with mobile and/or computing devices on a network are described in greater detail in commonly-assigned U.S. Patent Application Publication No. 2013/0030589, published Jan. 31, 2013, entitled LOAD CONTROL DEVICE HAVING INTERNET CONNECTIVITY, the entire disclosure of which is hereby incorporated by reference.

The operation of the load control system 100 may be programmed and configured using, for example, the mobile device 190 or other computing device (e.g., when the mobile device is a personal computing device). The mobile device 190 may execute a graphical user interface (GUI) configuration software for allowing a user 192 to program how the load control system 100 will operate. For example, the configuration software may run as a PC application or a web interface. The configuration software may be executed locally at the mobile device 190, and/or on the system controller 110 and/or the remote computing device 195. For example, the configuration software may be executed as a local application on the mobile device 190 that communicates with the system controller 110, load control devices, and/or the remote computing device 195 to operate as described herein. In another example, the configuration software may execute on the system controller 110 and/or the remote computing device 195 and may be displayed on the mobile device 190 via a local application (e.g., a browser) for displaying the GUI. The configuration software and/or the system controller 110 (e.g., via instructions from the configuration software) may generate the system configuration data that may include the load control dataset that defines the operation of the load control system 100. For example, the load control dataset may include information regarding the operational settings of different load control devices of the load control system (e.g., the lighting control device 120, the plug-in load control device 140, the motorized window treatments 150, and/or the thermostat 160). The load control dataset may comprise information regarding how the load control devices respond to inputs received from the input devices. The load control dataset may include the load control capabilities of one or more control devices, for example based on information (e.g., a load control type indicator) stored in memory (e.g., at the mobile device 190, the system controller 110, and/or the remote computing device 195). Examples of configuration procedures for load control systems are described in greater detail in commonly-assigned U.S. Pat. No. 7,391,297, issued Jun. 24, 2008, entitled HANDHELD PROGRAMMER FOR A LIGHTING CONTROL SYSTEM; U.S. Patent Application Publication No. 2008/0092075, published Apr. 17, 2008, entitled METHOD OF BUILDING A DATABASE OF A LIGHTING CONTROL SYSTEM; and U.S. Patent Application Publication No. 2014/0265568, published Sep. 18, 2014, entitled COMMISSIONING LOAD CONTROL SYSTEMS.

FIG. 1B is a block diagram illustrating an example of a device 130 capable of processing and/or communication in a load control system, such as the load control system 100 of FIG. 1A. In an example, the device 130 may be a control device capable of transmitting or receiving messages. The control device may be in an input device, such as a sensor device 141 (e.g., an occupancy sensor or another sensor device), a remote control device 170, or another input device capable of transmitting messages to load control devices or other devices in the load control system 100. The device 130 may be a computing device, such as the mobile device 190, the system controller 110, the remote computing device 195, a processing device, a central computing device, or another computing device in the load control system 100.

The device 130 may include a control circuit 131 for controlling the functionality of the device 130. The control circuit 131 may include one or more general purpose processors, special purpose processors, conventional processors, digital signal processors (DSPs), microprocessors, integrated circuits, a programmable logic device (PLD), application specific integrated circuits (ASICs), or the like. The control circuit 131 may perform signal coding, data processing, image processing, power control, input/output processing, or any other functionality that enables the device 131 to perform as one of the devices of the load control system (e.g., load control system 100) described herein.

The control circuit 131 may be communicatively coupled to a memory 132 to store information in and/or retrieve information from the memory 132. The memory 132 may comprise a computer-readable storage media or machine-readable storage media that maintains a device dataset of associated device identifiers, network information, and/or computer-executable instructions for performing as described herein. For example, the memory 132 may comprise computer-executable instructions or machine-readable instructions that include one or more portions of the procedures described herein. The control circuit 131 may access the instructions from memory 132 for being executed to cause the control circuit 131 to operate as described herein, or to operate one or more other devices as described herein. The memory 132 may comprise computer-executable instructions for executing configuration software and/or control software. For example, the computer-executable instructions may be executed to display a GUI for copying and pasting one or more settings as described herein. The computer-executable instructions may be executed to perform procedures 500 and/or 600 as described herein. Further, the memory 132 may have stored thereon one or more settings and/or control parameters associated with the device 130.

The memory 132 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 132 may be implemented as an external integrated circuit (IC) or as an internal circuit of the control circuit 131.

The device 130 may include one or more communication circuits 134 that are in communication with the control circuit 131 for sending and/or receiving information as described herein. The communication circuit 134 may perform wireless and/or wired communications. The communication circuit 134 may be a wired communication circuit capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 134 may be configured to communicate via power lines (e.g., the power lines from which the device 130 receives power) using a power line carrier (PLC) communication technique. The communication circuit 134 may be a wireless communication circuit including one or more RF or infrared (IR) transmitters, receivers, transceivers, and/or other communication circuits capable of performing wireless communications.

Though a single communication circuit 134 may be illustrated, multiple communication circuits may be implemented in the device 130. The device 130 may include a communication circuit configured to communicate via one or more wired and/or wireless communication networks and/or protocols and at least one other communication circuit configured to communicate via one or more other wired and/or wireless communication networks and/or protocols. For example, a first communication circuit may be configured to communicate via a wired or wireless communication link, while another communication circuit may be capable of communicating on another wired or wireless communication link. The first communication circuit may be configured to communicate via a first wireless communication link (e.g., a wireless network communication link) using a first wireless protocol (e.g., a wireless network communication protocol, and the second communication circuit may be configured to communicate via a second wireless communication link (e.g., a short-range or direct wireless communication link) using a second wireless protocol (e.g., a short-range wireless communication protocol).

One of the communication circuits 134 may comprise a beacon transmitting and/or receiving circuit capable of transmitting and/or receiving beacon messages via a short-range RF signal. The control circuit 131 may communicate with beacon transmitting circuit (e.g., a short-range communication circuit) to transmit beacon messages. The beacon transmitting circuit may communicate beacons via RF communication signals, for example. The beacon transmitting circuit may be a one-way communication circuit (e.g., the beacon transmitting circuit is configured to transmit beacon messages) or a two-way communication circuit capable of receiving information on the same network and/or protocol on which the beacons are transmitted (e.g., the beacon transmitting circuit is configured to transmit and receive beacon messages). The information received at the beacon transmitting circuit may be provided to the control circuit 131.

The control circuit 131 may be in communication with one or more input circuits 133 from which inputs may be received. The input circuits 133 may be included in a user interface for receiving inputs from the user. For example, the input circuits 133 may include an actuator (e.g., a momentary switch that may be actuated by one or more physical buttons) that may be actuated by a user to communicate user input or selections to the control circuit 131. In response to an actuation of the actuator, the control circuit 131 may enter an association mode, transmit association messages from the device 130 via the communication circuits 134, and/or receive other information (e.g., control instructions for performing control of an electrical load). In response to an actuation of the actuator, the control circuit may be configured to perform control by transmitting control instructions indicating the actuation on the user interface and/or the control instructions generated in response to the actuation. The actuator may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from a user. The control circuit 131 of the device 130 may enter the association mode, transmit an association message, transmit control instructions, or perform other functionality in response to an actuation or input from the user on the touch sensitive surface.

The input circuits 133 may include a sensing circuit (e.g., a sensor). The sensing circuit may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the device 130). The control circuit 131 may receive information from the one or more input circuits 133 and process the information for performing functions as described herein.

The control circuit 131 may be in communication with one or more output sources 135. The output sources 135 may include one or more indicators (e.g., visible indicators, such as LEDs) for providing indications (e.g., feedback) to a user. The output sources 135 may include a display (e.g., a visible display) for providing information (e.g., feedback) to a user. The control circuit 131 and/or the display may generate a graphical user interface (GUI) generated via software for being displayed on the device 130 (e.g., on the display of the device 130).

The user interface of the device 130 may combine features of the input circuits 133 and the output sources 135. For example, the user interface may have buttons that actuate the actuators of the input circuits 133 and may have indicators (e.g., visible indicators) that may be illuminated by the light sources of the output sources 135. In another example, the display and the control circuit 131 may be in two-way communication, as the display may display information to the user and include a touch screen capable of receiving information from a user. The information received via the touch screen may be capable of providing the indicated information received from the touch screen as information to the control circuit 131 for performing functions or control.

Each of the hardware circuits within the device 130 may be powered by a power source 136. The power source 136 may include a power supply configured to receive power from an alternating-current (AC) power supply or direct-current (DC) power supply, for example. In addition, the power source 136 may comprise one or more batteries. The power source 136 may produce a supply voltage V_{CC} for powering the hardware within the device 130.

FIG. 1C is a block diagram illustrating an example load control device 180. The load control device 180 may be a lighting control device (e.g., the lighting control device 120), a motorized window treatment (e.g., the motorized window treatments 150), a plug-in load control device (e.g., the plug-in load control device 140), a temperature control device (e.g., the temperature control device 160), a dimmer switch, a speaker (e.g., the speaker 146), an electronic switch, an electronic ballast for lamps, and/or another load control device.

The load control device 180 may include a control circuit 181 for controlling the functionality of the load control device 180. The control circuit 181 may include one or more general purpose processors, special purpose processors, conventional processors, digital signal processors (DSPs), microprocessors, integrated circuits, a programmable logic device (PLD), application specific integrated circuits (ASICs), or the like. The control circuit 181 may perform signal coding, data processing, image processing, power control, input/output processing, or any other functionality that enables the load control device 180 to perform as one of the devices of the load control system (e.g., load control system 100) described herein.

The load control device 180 may include a load control circuit 185 that may be electrically coupled in series between a power source 187 (e.g., an AC power source and/or a DC power source) and an electrical load 188. The control circuit 181 may be configured to control the load control circuit 185 for controlling the electrical load 188, for example, in response to received instructions. The electrical load 188 may include a lighting load, a motor load (e.g., for a ceiling fan and/or exhaust fan), an electric motor for controlling a motorized window treatment, a component of a heating, ventilation, and cooling (HVAC) system, a speaker, or any other type of electrical load. The electrical load may 188 be included in or external to the load control device 180. For example, the load control device 180 may be a dimmer switch or an LED driver capable of controlling an external lighting load. The electrical load 188 may be integral with the load control device 180. For example, the load control device 180 may be included in LEDs of a controllable light source, a motor of a motor drive unit, or a speaker in a controllable audio device.

The control circuit 181 may be communicatively coupled to a memory 182 to store information in and/or retrieve information from the memory 182. The memory 182 may comprise a computer-readable storage media or machine-readable storage media that maintains a device dataset of associated device identifiers, network information, and/or computer-executable instructions for performing as described herein. For example, the memory 182 may comprise computer-executable instructions or machine-readable instructions that include one or more portions of the procedures described herein. The memory 182 may have stored thereon one or more settings and/or control parameters associated with the device 180. For example, the memory 182 may have stored thereon one or more associations between control parameters and respective settings. The settings may be updated as described herein.

The control circuit 181 may access the instructions from memory 182 for being executed to cause the control circuit 181 to operate as described herein, or to operate one or more devices as described herein. The memory 182 may include a non-removable memory and/or a removable memory. The non-removable memory may include random-access memory (RAM), read-only memory (ROM), a hard disk, or any other type of non-removable memory storage. The removable memory may include a subscriber identity module (SIM) card, a memory stick, a memory card, or any other type of removable memory. The memory 182 may be implemented as an external integrated circuit (IC) or as an internal circuit of the control circuit 181.

The load control device 180 may include one or more communication circuits 184 that are in communication with the control circuit 181 for sending and/or receiving information as described herein. The communication circuit 184 may perform wireless and/or wired communications. The communication circuit 184 may be a wired communication circuit capable of communicating on a wired communication link. The wired communication link may include an Ethernet communication link, an RS-485 serial communication link, a 0-10 volt analog link, a pulse-width modulated (PWM) control link, a Digital Addressable Lighting Interface (DALI) digital communication link, and/or another wired communication link. The communication circuit 184 may be configured to communicate via power lines (e.g., the power lines from which the load control device 180 receives power) using a power line carrier (PLC) communication technique. The communication circuit 184 may be a wireless communication circuit including one or more RF or IR transmitters, receivers, transceivers, or other communication circuits capable of performing wireless communications.

Though a single communication circuit 184 may be illustrated, multiple communication circuits may be implemented in the load control device 180. The load control device 180 may include a communication circuit configured to communicate via one or more wired and/or wireless communication networks and/or protocols and at least one other communication circuit configured to communicate via one or more other wired and/or wireless communication networks and/or protocols. For example, a first communication circuit may be configured to communicate via a wired or wireless communication link, while another communication circuit may be capable of communicating on another wired or wireless communication link. The first communication circuit may be configured to communicate via a first wireless communication link (e.g., a wireless network communication link) using a first wireless protocol (e.g., a wireless network communication protocol), and the second communication circuit may be configured to communicate via a second wireless communication link (e.g., a short-range or direct wireless communication link) using a second wireless protocol (e.g., a short-range wireless communication protocol).

One of the communication circuits 184 may comprise a beacon transmitting and/or receiving circuit capable of transmitting and/or receiving beacon messages via a short-range RF signal. A control circuit 181 may communicate with beacon transmitting circuit (e.g., a short-range communication circuit) to transmit beacon messages. The beacon transmitting circuit may communicate beacon messages via RF communication signals, for example. The beacon transmitting circuit may be a one-way communication circuit (e.g., the beacon transmitting circuit is configured to transmit beacon messages) or a two-way communication circuit capable of receiving information on the same network and/or protocol on which the beacon messages are transmitted (e.g., the beacon transmitting circuit is configured to transmit and receive beacon messages). The information received at the beacon transmitting circuit may be provided to the control circuit 181.

The control circuit 181 may be in communication with one or more input circuits 183 from which inputs may be received. The input circuits 183 may be included in a user interface for receiving inputs from the user. For example, the input circuits 183 may include an actuator (e.g., a momentary switch that may be actuated by one or more physical buttons) that may be actuated by a user to communicate user input or selections to the control circuit 181. In response to an actuation of the actuator, the control circuit 181 may enter an association mode, transmit association messages from the load control device 180 via the communication circuits 184, and/or receive other information. In response to an actuation of the actuator may perform control by controlling the load control circuit 185 to control the electrical load 188, and/or by transmitting control instructions indicating the actuation on the user interface and/or the control instructions generated in response to the actuation. The actuator may include a touch sensitive surface, such as a capacitive touch surface, a resistive touch surface an inductive touch surface, a surface acoustic wave (SAW) touch surface, an infrared touch surface, an acoustic pulse touch surface, or another touch sensitive surface that is configured to receive inputs (e.g., touch actuations/inputs), such as point actuations or gestures from a user. The control circuit 181 of the load control device 180 may enter the association mode, transmit an association message, control the load control circuit 185, transmit control instructions, or perform other functionality in response to an actuation or input from the user on the touch sensitive surface.

The input circuits 183 may include a sensing circuit (e.g., a sensor). The sensing circuit may be an occupant sensing circuit, a temperature sensing circuit, a color (e.g., color temperature) sensing circuit, a visible light sensing circuit (e.g., a camera), a daylight sensing circuit or ambient light sensing circuit, or another sensing circuit for receiving input (e.g., sensing an environmental characteristic in the environment of the load control device 180). The control circuit 181 may receive information from the one or more input circuits 183 and process the information for performing functions as described herein.

The control circuit 181 may illuminate a light sources 186 (e.g., LEDs) to provide feedback to a user. The control circuit 181 may be operable to illuminate the light sources 186 different colors. The light sources 186 may be illuminated by, for example, one or more light-emitting diodes (LEDs).

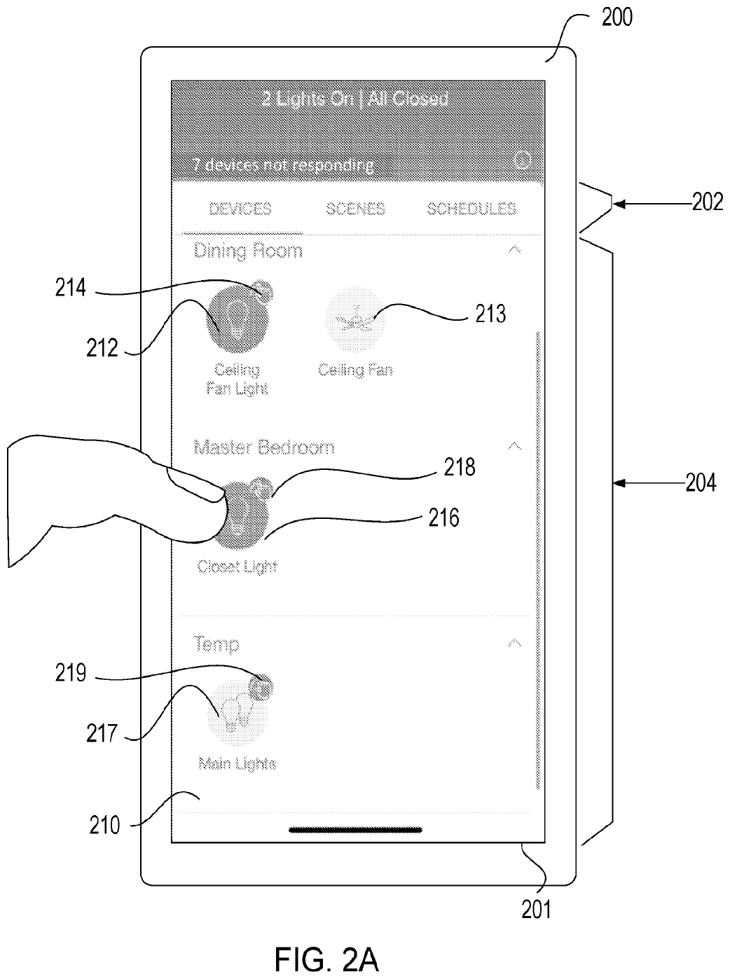

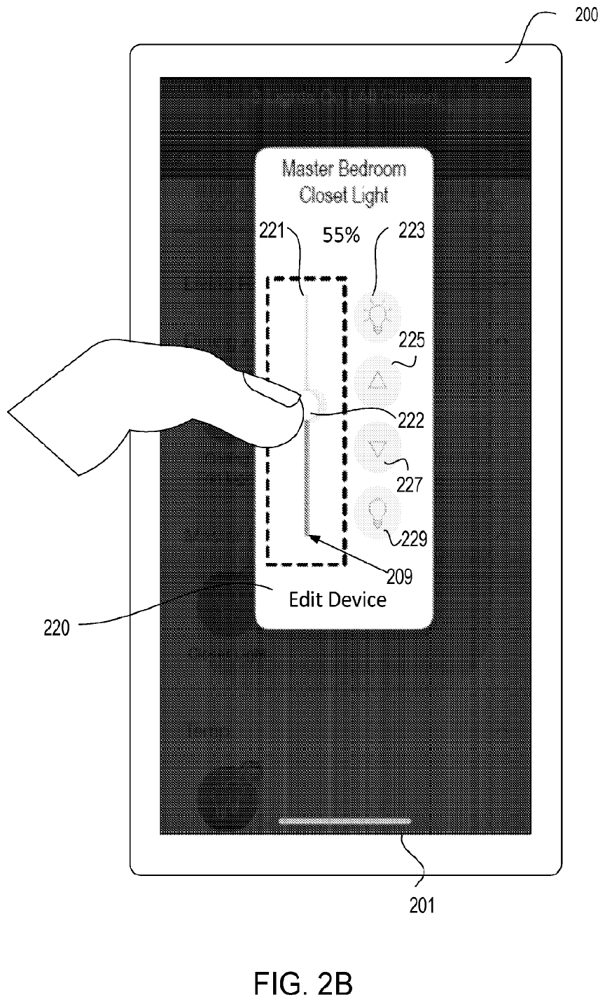

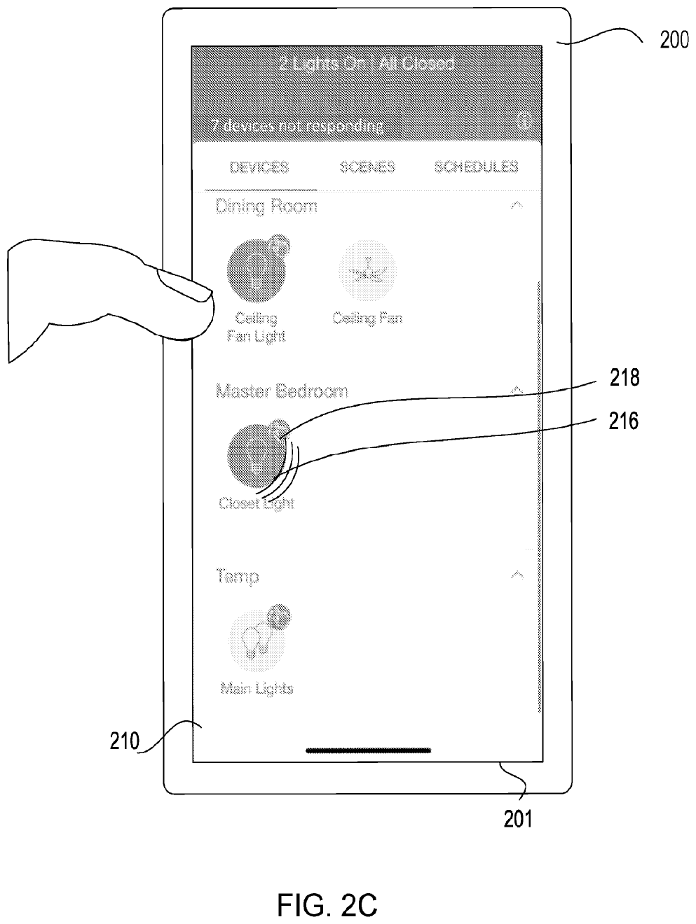

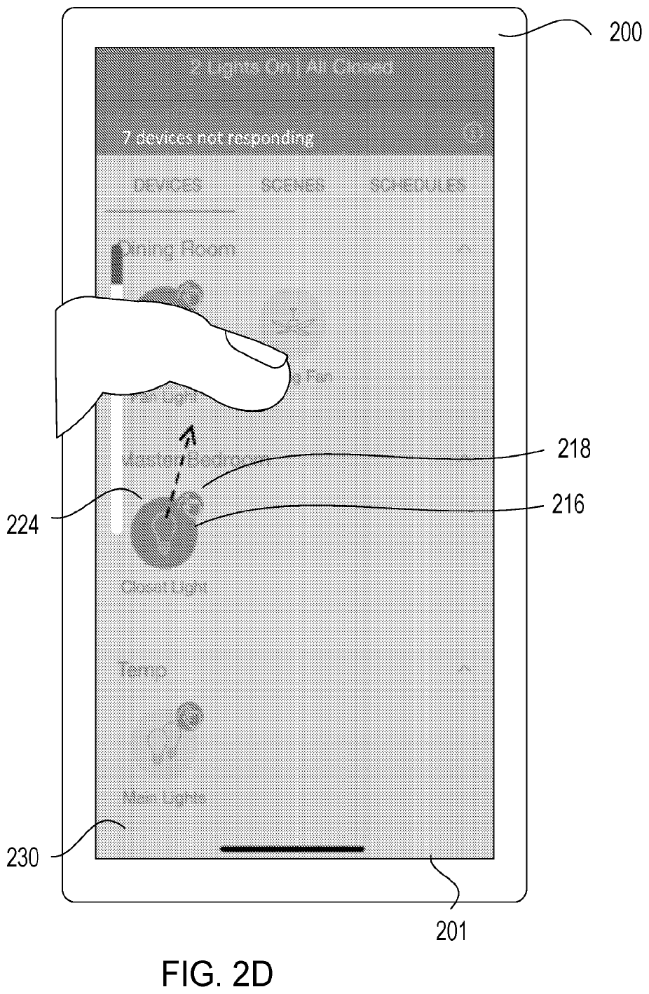

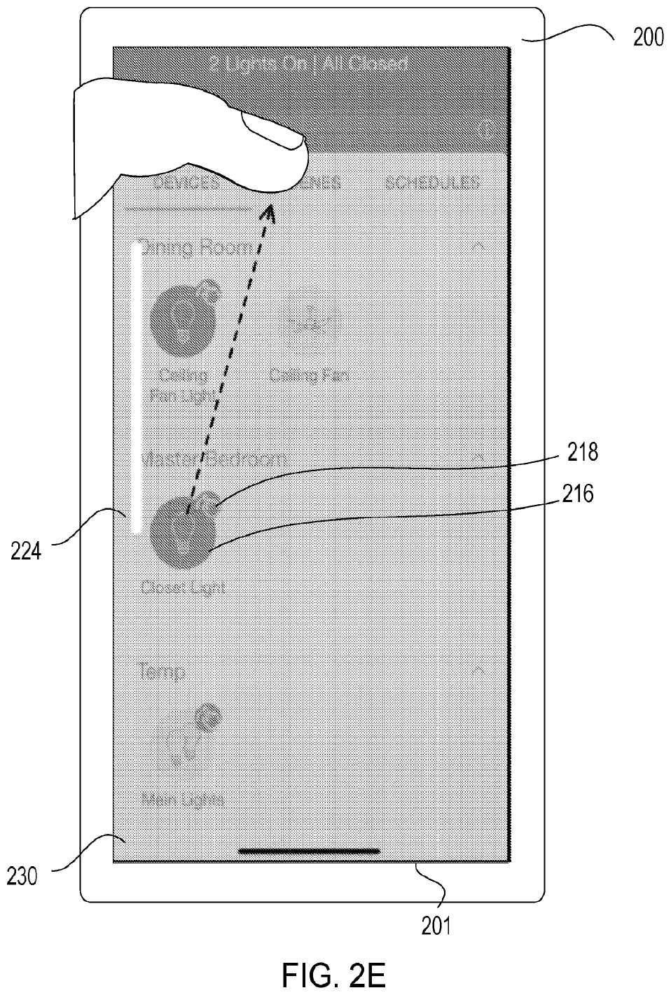

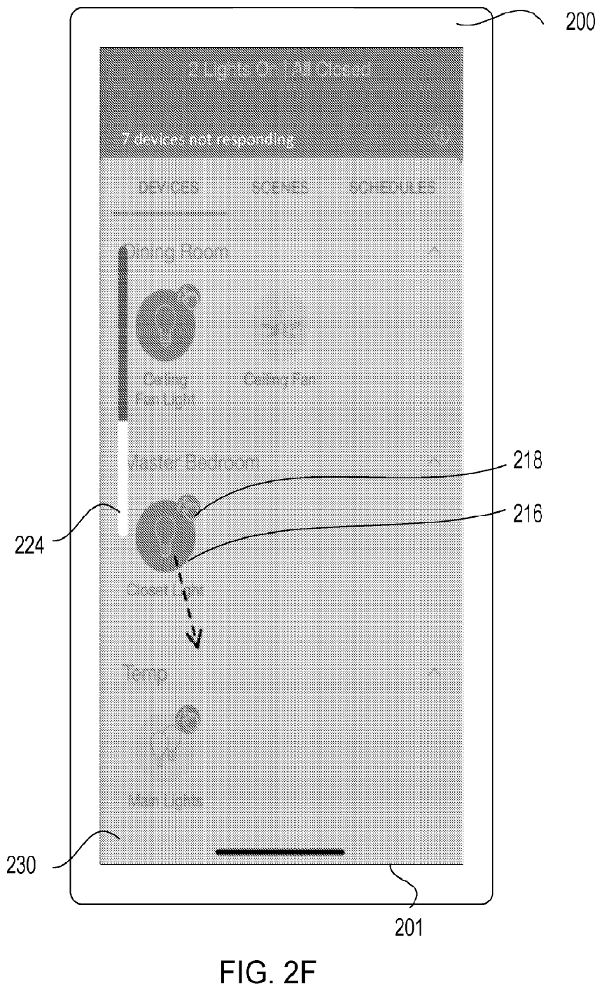

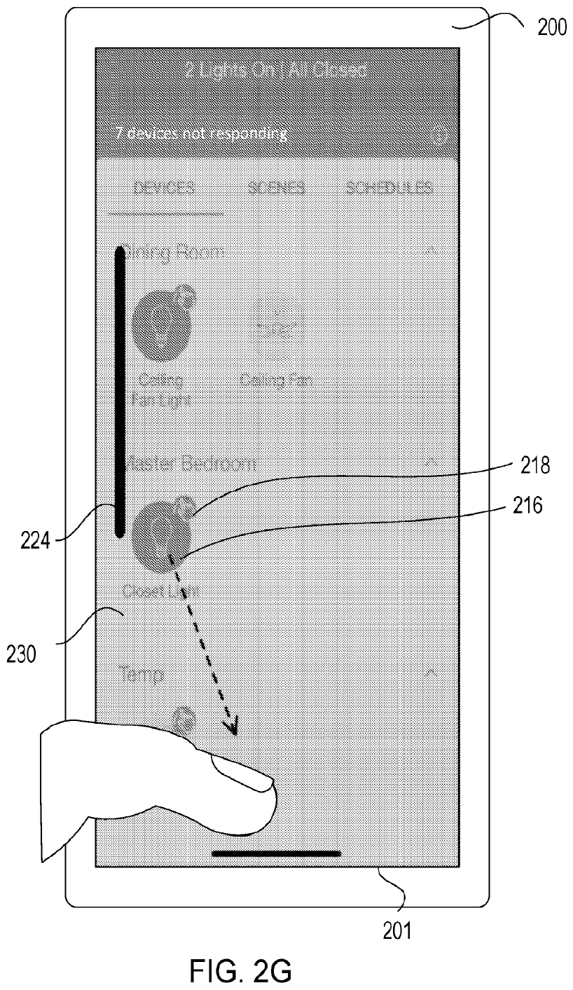

Turning now to FIG. 2A, there is shown a graphical user interface 210 that may be displayed on a display 201 of a mobile device 200. For example, the graphical user interface 210 may be displayed in response to execution of control software by the control circuit that is stored in memory on the computing device 200. The control software may be executed by one or more control circuits on one or more devices. For example, the control software may be executed locally by a mobile device (e.g., the mobile device 200) that is capable of sending and receiving messages for providing control information and/or performing control. The mobile device may display a user interface generated remotely by another device (e.g., a system controller or a remote computing device). The graphical user interface 210 may display to a user via mobile device 200 upon the application executing (such as by the user selecting and executing the application at the mobile device 200) for enabling configuration and/or control of one or more electrical loads in a load control system (e.g., the load control system 100 shown in FIG. 1A). Information displayed in the graphical user interface 210 may be based on information obtained by the control software (e.g., from the system controller 110 and/or remote control device 195 shown in FIG. 1A) upon the application being executed. The graphical user interface 210 may include one or more sections (which may also be referred to herein as panes or areas or spaces). For example, a first section (e.g., a menu selection section 202) may provide the user with selectable tabs. Here, three tabs are shown including a Devices tab, a Scenes tab, and a Schedules tab, although the section may include fewer or additional tabs, including the three tabs being in an order different than that shown. The menu selection section 202 may be scrollable left to right to display additional tabs, for example. If the Devices tab is selected, the control software may display one or more electrical loads and/or devices (e.g., electrical loads, such as lighting loads, and/or load control devices controlling electrical loads) for being controlled. If the Scenes tab is selected, the control software may display one or more scenes (e.g., presets) for being selected. If the Schedules tab is selected, the control software may display one or more timing schedules for controlling electrical loads at predetermined times.

The control software may change and/or display information in a second section (e.g., a load control information section 204) in response to the tab that is selected. For example, the control circuit of the mobile device 200 may display electrical loads and/or load control devices controlling electrical loads in the load control information section 204 of the graphical user interface 210 in response to user actuation of the Devices tab, one or more scenes for being selected in response to user actuation of the Scenes tab, and one or more timing schedules for controlling electrical loads in response to user actuation of the Schedules tab. In general, the load control information section 204 of the graphical user interface 210 may provide the user with different status information and controls for controlling and/or configuring devices in the load control system. In the example of FIG. 2A, the Devices tab is active. Here, the load control information section 204 shows information corresponding to the Devices tab. Upon the control software executing at the control circuit of the mobile device 200, the control circuit of the mobile device 200 may default the graphical user interface 210 to display the Devices tab as being active, although one of the other tabs may also be the default-active tab.

The load control information section 204 may include icons representing one or more control devices (e.g., groups of control devices). The control devices may be grouped by, for example, room, area, and/or another grouping. For example, as shown in FIG. 2A, the load control information section 204 may include one or more control devices in a “Dining Room” area, one or more control devices in a “Master Bedroom” area, and one or more control devices in a “Temp” area. Each area may include one or more zones configured for being controlled (e.g., collectively controlled) within the area. As shown in FIG. 2A, the load control information section 204 may display one or more icons representing control devices in each area. For example, the load control information section 204 of the graphical user interface 210 may display an icon 212 representing a first control device (e.g., a load control device controlling a ceiling fan light) and an icon 213 representing a second control device (e.g., a load control device controlling a ceiling fan) in the “Dining Room” area. The load control information section 204 of the graphical user interface 210 may display an icon 216 representing a control device (e.g., a load control device controlling a closet light) in the “Master Bedroom” area. The load control information section 204 of the graphical user interface 210 may display an icon 217 representing a load control device (e.g., one or more main lights) in the “Temp” area (e.g., which may be in an off state, as represented by the color of the icon 217). An icon representing a given load control device may be displayed with the name of the electrical load controlled by the load control device. For example, the icon 216 may represent a load control device that controls a closet light, and may be referred to using the name “Closet Light.” Further, an icon representing a given load control device may indicate a status (e.g., an on/off status) of the control device. For example, as shown in FIG. 2A, the icon may indicate whether the load control device is currently on (e.g., by displaying the icon in a first color) or off (e.g., by displaying the icon in a second color). The status may be indicated via a color of the icon, a pattern of the icon, or another indication.

The load control information section 204 may display gesture control icons 214, 218, and 219 indicating that the control devices represented by the icons 212, 216, and 217, respectively, are available for gesture control. Additionally and/or alternatively, the load control information section 204 may indicate that the load control devices represented by the icons 212, 216, and 217 are available for gesture control by modifying the icons 212, 216, and 217. The load control devices that are available for gesture control may be devices that have variable levels of control of electrical loads (e.g., dimmable electrical loads). For example, load control devices that are available for gesture control may include dimmable lighting loads with variable intensity levels, motorized window treatments with variable levels for controlling a covering material, speakers with variable volume levels, and/or another type of control device with variable levels of control. Load control devices that are able to toggle an electrical load between a fully on state and a fully off state (e.g., non-dimmable and/or switched electrical loads) may also be available for gesture control. Different gesture control icons may be displayed to identify different types of gesture control.

The control circuit of the mobile device 200 may detect an actuation of an icon representing a control device in the load control information section 204, and the control circuit of the mobile device 200 may display information about the selected control device corresponding to the actuated icon via the control software. For example, as shown in FIG. 2A, the control circuit of the mobile device 200 may detect an actuation of the icon 216 representing the master bedroom closet light. The control circuit of the mobile device 200 executing the control software may enter a load control mode when the user selects the icon 216.

Turning now to FIG. 2B, the control circuit executing the control software may display a control interface 220 after the user has actuated the icon 216, for example after the user has pressed and released the icon 216 (e.g., with the user's finger remaining in contact with the icon 220 for less than a predetermined amount of time, which may be referred to as a “transitory actuation”). Control interface 220 may be shown alone or superimposed over the graphical user interface 210, for example. The control interface 220 and/or the elements therein may be displayed in a predefined location on the display of the mobile device 200. One will recognize that control interface 220 is an example and other controls are possible. The control circuit executing the control software may determine the load control capabilities of the selected device based on information (e.g., a load control type indicator) stored in memory at the mobile device and/or provided by another device (e.g., a system controller or a remote computing device). For example, the control circuit executing the control software may determine from the load control type indicator of the selected “Master Bedroom Closet Light” whether the “Master Bedroom Closet Light” has on/off, intensity control, color control, or other lighting control capabilities. Based on this determination, the control circuit executing the control software may display an appropriate control interface. In this example, the “Master Bedroom Closet Light” may be determined as being capable of on/off control and/or lighting intensity control. The control software may display control interface 220 with an intensity adjustment actuator (e.g., a slider control). The intensity adjustment actuator may include a slider slot 221 and a movable (e.g., slidable) slider knob 222 (e.g., a vertically-movable actuator) that may be actuated and/or moved by the user. The slider slot 221 may operate as a status bar that shows a present intensity level of the load control device. The control interface 220 may indicate status of the lighting load via the position of the slider knob 222 on the slider slot 221, and/or via color or pattern of a portion of the slider slot 221 that indicates intensity level. Other load control devices may similarly have their status displayed and be controlled via a control interface similar to control interface 220. The control interface 220 may be displayed in a predefined location on the display of the mobile device 200. The intensity level of the “Master Bedroom Closet Light” may be increased or decreased by moving the actuator up or down on the slider slot 221, and/or via one of the buttons shown next to the slider slot 221 in FIG. 2B. For example, the user may press the on button 223 to turn on the control device, the increase button 225 to increase the intensity of the load control device, the decrease button 227 to decrease the intensity of the load control device, or the off button 229 to turn off the control device.

The control circuit executing the control software may display the position of the slider knob 222, as in this example, to provide an indication to the user of a present intensity level of the lights (e.g., the actuator is positioned at approximately 55% of the length of the slider slot 221). The status may be received in response to changes in lighting control at the lighting control device for which the status is being provided (e.g., “Master Bedroom Closet Light”) or a query message transmitted to the lighting control device or the system controller. Based on detecting movement of slider knob 220 (e.g., actuator) by the user (such as raising or lowering the slider knob 220) or pressing the buttons 223, 225, 227, or 229, the control circuit executing the control software may communicate one or more messages (e.g., directly or via the system controller 110) to instruct the lighting control device to control the corresponding lighting load based on the user's instructions. The control circuit may update the status indicated on the slider slot 221 in response to the input received from the user and the messages received from the lighting load. If the user turns the lights off such as by moving the slider knob 222 to a lowest position of the slider slot 221 at 209, the control circuit may update the graphical user interface 210 shown in FIG. 2A by removing or altering the appearance of the icon corresponding to the “Master Bedroom Closet Light.” In another example, moving the slider knob 222 to the lowest position of the slider slot 221 may cause the lighting load to remain in an on state, but at a minimum intensity level.

While FIG. 2B shows a control interface for controlling a load control device via a first load control mode, the control circuit executing the control software may allow for load control in other load control modes for controlling a corresponding load control device represented by an icon based on the type of user actuation that is performed on the icon. For example, as discussed below, the control circuit executing the control software may allow for the load control device to be controlled via gesture control.

Referring again to FIG. 2A, as described above, the control software may enter a first load control mode when the user performs a first interaction with an icon (e.g., the icon 216) on the graphical user interface 210 and a second load control mode when the user performs a second interaction with the icon (e.g., the icon 216) on the graphical user interface 210. For example, if the user actuates the icon for less than a pre-determined amount of time (e.g., a transitory actuation), the control software may enter the first load control mode and show the control of FIG. 2B, while if the user actuates the icon for at least the pre-determined amount of time, the control software may enter the second load control mode and provide a different control interface as describe below. In another example, the control software may enter the first load control mode if the user single taps the icon and may enter the second load control mode if the user double taps the icon. The graphical user interface 210 may indicate which control devices are available to be controlled using the second control mode by adding respective gesture icons next to the icons representing the available control devices. For example, as shown in FIG. 2A, the graphical user interface 200 being displayed by the control circuit executing the control software may display icons 214, 218, 219 indicating the respective control devices that are available for gesture control (e.g., the second load control mode).

Turning now to FIG. 2C, the control circuit executing the control software may detect a user interaction with an icon representing a control device that causes the control circuit to enter the second load control mode for controlling the control device. The user interaction with the icon that causes the control circuit to enter the second load control mode may be different than the user interaction with the icon that causes the control circuit to enter the first load control mode. For example, as shown in FIG. 2C, the control circuit may detect that the user has actuated the master bedroom closet light icon 216 for a predefined period of time (e.g., or otherwise performed an action that indicates that the control software should enter the second load control mode) in order to enter the second load control mode for that control device. The control circuit may cause the mobile device 200 to provide haptic feedback to the user to indicate that the control software has entered the second load control mode. Turning now to FIG. 2D, the control circuit executing the control software may cause the mobile device 200 to display a control interface 230 after the user has actuated the icon 216 for at least the predetermined amount of time. Control interface 230 may be shown alone or superimposed over the graphical user interface 210, for example. The control interface 230 may be transparent, and may be overlaid over the graphical user interface 210 such that the graphical user interface 210 (e.g., and the information about the load control devices displayed in the graphical user interface 210) is visible while the control interface 230 is displayed. One will recognize that control interface 230 is an example and other control interfaces are possible. The control circuit executing the control software may display the control interface 230 with a status bar 224 that provides an indication to the user of a present intensity level of the control device (e.g., a dimming state of the master bedroom closet light). The control circuit executing the control software may determine the load control capabilities of the selected device based on information (e.g., a load control type indicator) stored in memory at the mobile device and/or provided by another device (e.g., a system controller or a remote computing device).

The user may use the control interface 230 to change the intensity level of the control device. For example, the load control device may be a dimmer switch for controlling a dimmable lighting load with a variable intensity level, a motorized window treatment providing control of a variable position of a covering material, a motor control device for controlling a variable speed of a motor load (e.g., a ceiling fan and/or an exhaust fan), a temperature control device (e.g., a thermostat) for controlling a temperature (e.g., a setpoint temperature) of a temperature control system (e.g., a heating, ventilation, and air conditioning system), an audio control device (e.g., a speaker) with a variable volume level, and/or another type of control device with a variable control level. For example, the control circuit of the mobile device 200 may detect a press and drag gesture (e.g., or another gesture) on the display of the mobile device 200 to increase and/or decrease the intensity level of the control device. The control circuit of the mobile device 200 may detect a press and drag gesture in a first direction or axis to perform load control and disregard gestures performed in a second direction or axis. For example, as described herein, the first axis may be a vertical axis and the second axis may be a horizontal axis.

The gesture in a given direction may be a gesture that is substantially performed in that direction or performed within a certain threshold in a given direction. For example, the control circuit may identify a gesture that is performed within 10 degrees, 30 degrees, 45 degrees, 60 degrees (or another threshold) of the vertical or horizontal axis as being a gesture performed in the direction of that axis. When a gesture is performed within a threshold, the control circuit may identify a distance in the direction (e.g., vertical or horizontal direction) on a predefined axis for performing control (e.g., total distance in vertical or horizontal direction, whether gesture is performed on vertical or horizontal axis or at another angle), or a distance of the gesture between two points (e.g., distance of gesture performed at an angle off of vertical or horizontal axis) for determining the level of control to perform in response to the gesture.

The control circuit executing the control software may detect a gesture (e.g., a press and drag) in an upward direction to increase the intensity level of the load control device. The control circuit may detect a gesture in a downward direction to decrease the intensity level of the load control device. In response to detecting a predefined gesture in the upward direction or downward direction, the control circuit may transmit one or more messages configured to change the intensity level of the load control device by an amount that is directly related to the distance of the gesture. For example, the control circuit may be configured to adjust the intensity level of the load control device between a maximum intensity level L_{MAX} (e.g., a high-end intensity, such as 100%) and a minimum intensity level L_{MIN} (e.g., a low-end intensity, such as 1%-10%). The control circuit may disregard any motion of the user's finger in a horizontal direction or axis. Other variable load control devices may be similarly controlled to a max level and/or min level, as described herein.

The control circuit may disregard the motion of the user's finger or other gesture in the horizontal direction or axis to allow the user to perform the gesture for enabling load control on another location of the display 201 of the mobile device 200. For example, the control circuit may disregard motion of the user's finger or other gesture when the gesture is performed outside of a predefined threshold of a given direction (e.g., vertical or horizontal axis). The user may move their finger to another location to perform load control without obstructing the status bar 224 that shows the present status of the electrical load being controlled. The status bar 224 may be updated to reflect the present status of the electrical load, for example as described herein.

The control circuit may continue to display the control interface 230 (e.g., while in the second load control mode) while the user's finger continues to be detected as making contact with the display 201 of the mobile device 200 after selecting the icon 216 for the predefined period of time. Once the control circuit fails to detect the user's finger as making contact with the display of the mobile device 200, the control circuit of the mobile device 200 may exit the second control mode and/or may stop displaying the control interface 230 (e.g., display the graphical control interface 210). This may allow for the user to touch the display to activate gesture control and perform continued control after an initial actuation. The user may let their finger off of the display to deactivate the gesture control and/or the second load control mode. For example, after the user releases their finger from the display, the user may perform control by interacting with the icon 216 as shown in FIG. 2A. The user may re-engage the icon to enter the first load control mode or to enter the second load control mode again. If the user engages the icon and the control circuit enters the first load control mode, the control circuit may remain in the first load control mode (e.g., as shown in FIG. 2B) when the user releases their finger from the display. The user may deactivate the first control mode by actuating an icon (e.g., exit icon or an “x” icon) displayed on the display of the mobile device 200.

The control circuit executing the control software may determine an amount by which to increase or decrease the intensity level of the load control device based on a vertical distance of the user's gesture. For example, the control circuit may determine the amount by which to increase or decrease the intensity level of the load control device by multiplying the vertical distance of the user's gesture by a control ratio CR, which defines a predetermined amount of change on the intensity level per unit of vertical distance of the user's gesture (e.g., 25% per half inch). When the control software enters the second load control mode, the control circuit executing the control software may determine a present intensity level for the load control device and a position of the user's finger on the display of the mobile device 200 (e.g., a vertical position along the length of the display or y-coordinate). For example, the control circuit executing the control software may determine the position of the user's finger on a relative scale of 0 (e.g., the bottom edge of the display) to 255 (e.g., the top edge of the display). Alternatively, another scale may be used. The control circuit executing the control software may then determine a maximum position (e.g., an upper limit Y_{MAX}) and a minimum position (e.g., a lower limit Y_{MIN}) based on the present intensity level L_{PRES} for the control device, the position Y_{PRES} of the user's finger, and the control ratio CR, e.g.,

$${Y}_{MAX} = {Y}_{PRES} + ( {L}_{MAX} - {L}_{PRES} ) / CR ; and$$

$${Y}_{MIN} = {Y}_{PRES} - ( {L}_{PRES} - {L}_{MIN} ) / CR .$$

The upper limit Y_{MAX} may be a position on the display of the mobile device 200 that represents an upper bound for controlling the load control device, and the lower limit Y_{MIN} may be a position on the display of the mobile device 200 that represents a lower bound for controlling the load control device. For example, if the control circuit executing the control software determines that the present intensity level L_{PRES} of the device is 100% (e.g., at a maximum intensity level) and that the position of the user's finger Y_{PRES} is halfway between the top edge of the display and the bottom edge (e.g., at approximately 128 on a scale from 0 to 255), the control circuit executing the control software may determine the position of the user's finger to be the Y upper limit Y_{MAX}. The control circuit executing the control software may ignore gestures made by the user that are below the lower limit Y_{MIN} or above the upper limit Y_{MAX}. For example, if the upper limit Y_{MAX} is halfway between the top edge of the display and the bottom edge, the control circuit executing the control software may ignore any gestures made by the user that are in the top half of the display. The control circuit may change the dimming with regard to changes in the gesture on the y-axis within the defined range. The control circuit may disregard changes in the gesture on the x-axis. However, the control circuit may operate similarly on the x-axis, while disregarding changes in the gesture on the y-axis.

As noted above, the control circuit may change the intensity level of the control device by a greater amount the larger the vertical distance of the gesture. For example, as shown in FIGS. 2D and 2E, the control software may increase the intensity level of the control device (e.g., the electrical load controlled by the control device) by approximately 25% for an upward gesture over a distance of half an inch, and may increase the intensity level by approximately 50% for an upward gesture over a distance of one inch. Conversely, as shown in FIGS. 2F and 2G, the control software may decrease the intensity level of the control device by approximately 25% for a downward gesture over a distance of half an inch, and may decrease the intensity level by approximately 50% for a downward gesture over a distance of one inch. If the gesture reaches the lower limit Y_{MIN}, the control software may decrease the intensity level to the minimum intensity level L_{MIN} or may turn off the control device. As noted above, the status bar 224 may display the updated intensity level of the control device (e.g., based on feedback received from the load control device).

This form of control may allow the user to perform control in the second load control mode by gesturing in a direction on the display of the mobile device 200 and perform relatively larger changes in the level of control with larger gestures and relatively smaller changes in the level of control with relatively smaller gestures. In the second load control mode, the user may perform control using a larger portion of the display than in the first load control mode. For example, the first load control may allow the user to perform control when the user moves the slider knob 222 within the slider slot 221, which may require the user to look closely at the display of the mobile device 200 and perform control within a specifically defined area of the display. In the second load control mode, the user may perform control using gestures and without operating within such a specifically defined area of the display. Often times when setting up the load control system or performing control, a user may be looking at the control of the electrical load itself for fine-tuned adjustments. This may make it difficult to appreciate the changes in the level of control (e.g., dimming, etc.) that are being performed at the electrical load itself.

Referring again to FIG. 2C, the control circuit executing the control software may detect a user interaction with an icon representing a control device that causes the control circuit to enter a third load control mode for controlling the control device. The user interaction with the icon that causes the control circuit to enter the third load control mode may be different than the user interaction with the icon that causes the control circuit to enter the first load control mode, and may be the same as or different from the user interaction with the icon that causes the control circuit to enter the second load control mode. For example, the control circuit of the mobile device 200 may enter the third load control mode if the control device represented by the icon 216 is not a dimmable control device, but rather toggles between two selectable options. For example, the control device may have the ability to toggle between fully-on and fully-off states. The control circuit may determine whether to enter the second load control mode or the third control mode by looking up the device type of the control device, which may be stored in memory, and may display a control interface based on the device type (e.g., on/off or dimming depending on the device type). For example, the control circuit may enter the second load control mode if the device type of the control device indicates that the control device is a dimmer and/or is dimmable, and may enter the third control mode if the device type of the control device indicates that the control device is a switch and/or is switchable. In another example, the control circuit may detect a third user interaction with the icon that causes the control circuit to enter a third load control mode. The third user interaction may be different than the first user interaction that causes the control circuit to enter the first load control mode and may be different than the second user interaction that causes the control circuit to enter the second load control mode. For example, the third user interaction may be an actuation for a predefined period of time and/or a gesture in a predefined direction on the display of the mobile device 200.

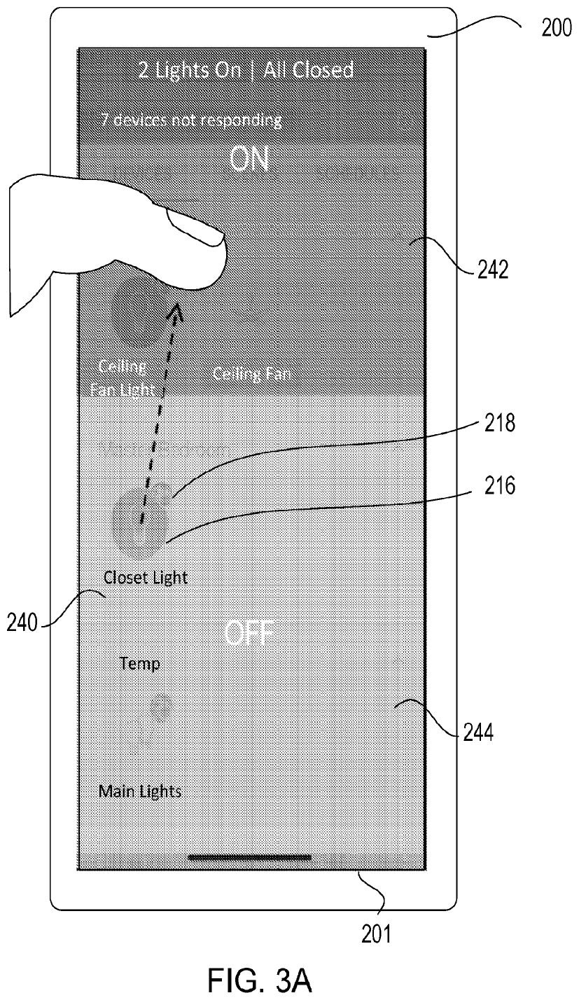

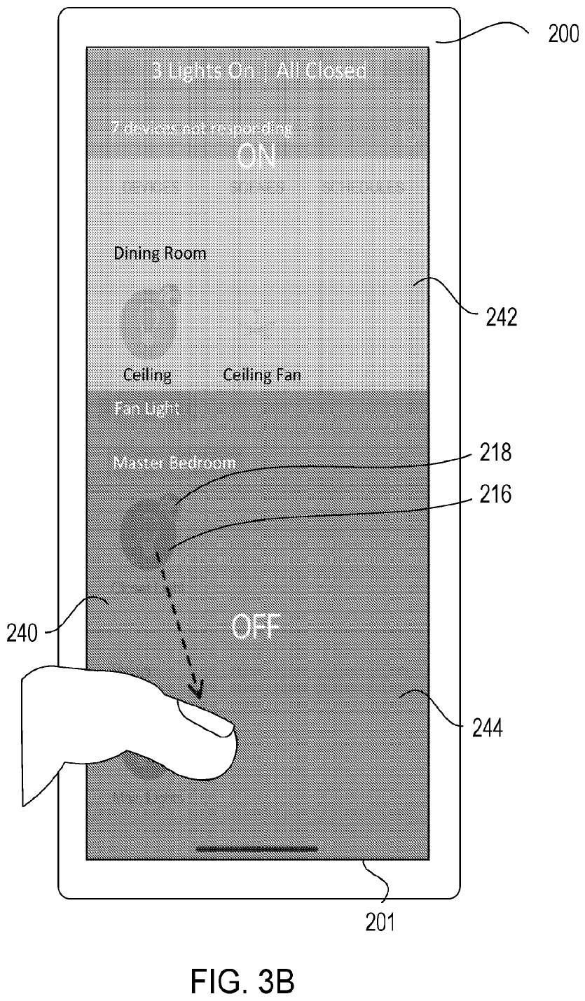

FIGS. 3A and 3B show an example control interface 240 that the control circuit executing the control software may display while in the third load control mode. The control interface 240 may be shown alone or superimposed over the graphical user interface 210, for example. The control interface 230 may be transparent, and may be overlaid over the graphical user interface 210 such that the graphical user interface 210 (e.g., and the information about the load control devices displayed in the graphical user interface 210) is visible while the control interface 230 is displayed. One will recognize that the control interface 240 is an example and other controls are possible. The control interface 240 may be divided into two sections, for example an “On” section 242 and an “Off” section 244. One of the sections may be highlighted to indicate the current state of the load control device. Though an “On” section 242 and an “Off” section 244 are shown as examples, other absolute forms of control may be similarly implemented (e.g., “Up” section and “Down” section, etc.).

The user may use the control interface 240 to change a state of the control device. For example, the control circuit executing the control software may detect a press and drag gesture (e.g., or another gesture) on the display of the mobile device 200. The control circuit may determine that the load control device being controlled by the icon that is selected is configured to perform absolute control and display the control interface 230 to enable the user to perform absolute control, such as allowing the user to turn the control device (e.g., an electrical load controlled by the control device) on or off. The regions of the control interface 230 may be predefined or may be configured based on the location of the icon that is selected on the display of the mobile device 200. The control circuit may then detect when the user's gesture enters a region of the display of the mobile device 200 for enabling absolute control. Detecting a gesture that enters a first region of the display of the mobile device 200 may cause the electrical load to enter a first state, and detecting a gesture that enters a second region of the display of the mobile device 200 may cause the electrical load to enter a second state. For example, detecting a gesture that enters an upper region (e.g., a top half) of the display may cause the electrical load to turn on, and detecting a gesture that enters a lower region (e.g., a bottom half) of the display may cause turn the electrical load to turn off. The control circuit may monitor an endpoint of the press and drag gesture and determine when the endpoint of the press and drag gesture is in a predefined region of the display. In response to detecting a predefined gesture that enters the first region or the second region, the control circuit may transmit one or more messages configured to change the state of the electrical load. The control circuit may disregard any motion of the user's finger in a horizontal direction or that stays in the same region.

The control circuit executing the control software may implement hysteresis such that the electrical load does not rapidly change between the first and second states if the user's finger is near a border between the first and second regions. For example, if the electrical load is changed to the first state at a given time, the control circuit executing the control software may expand the first region by moving the border between the first region and the second region in the direction of the second region. If the user's finger moves into the second region (e.g., the electrical load enters the second state), the control circuit executing the control software may expand the second region by moving the border between the first region and the second region in the direction of the first region. The control interface 240 may be displayed (e.g., the control software may be in the third load control mode) while the user's finger is making contact with the display of the mobile device 200 (e.g., once the user's finger stops making contact with the display of the mobile device 200, the mobile device 200 may exit the third control mode and/or may stop displaying the control interface 240). Based on detecting the user's gesture, the control software may communicate one or more messages to the system controller 110 to instruct the controller to turn the electrical load controlled by the control device on or off based on the user's instructions. The control interface 240 may change whether the “On” section 242 or the “Off” section 244 is highlighted based on the user's gesture (e.g., press and drag gesture).

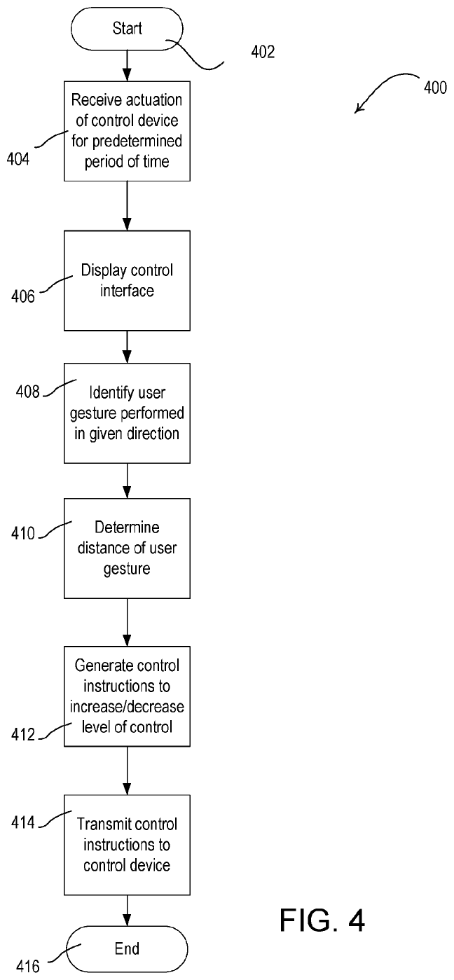

FIG. 4 is an example flowchart of a control procedure 400 for controlling the control level of a load control device via user actuation of an icon on a display of a mobile device. The procedure 400 may be performed by the mobile device, such as the mobile device 200. For example, the mobile device may be a mobile device associated with a user. One or more portions of the procedure 400 may be stored in memory and executed as computer-readable instructions by one or more control circuits, such as the control circuit operating the control software on the mobile device. Though the procedure 400 may be described herein as being performed by a single device, such as a mobile device, the procedure 400 may be distributed across multiple devices.

As shown in FIG. 4, the control procedure 400 may start at 402, for example, when the mobile device receives an actuation on the display. The control circuit of the mobile device may determine, at 404, that an actuation of an icon representing a control device has been received for a predetermined period of time. At 406, the control circuit may display a control interface. At 408, the control circuit may identify a user gesture performed in a given direction. The direction may be in a vertical or horizontal axis on the display of the mobile device, for example. The direction of the gesture may also, or alternatively, be within a predefined threshold of the vertical or horizontal axis, as described herein. The user gesture may be performed while the actuation is maintained. At 410, the control circuit may determine the distance of user gesture. At 412, the control circuit may generate control instructions to adjust a control level of the electrical load. For example, the control instructions may increase or decrease a control level for a corresponding electrical load. The control instructions generated may be based on the distance determined by the user gesture. For example, the control instructions may increase or decrease an intensity level of a lighting load or a level of a covering material on a motorized window treatment in response to the distance of the gesture.

The control level may be limited by a maximum position and/or a minimum position based on the present control level of the electrical load. For example, the position of the user's finger may be determined by the control circuit at the time of the user's actuation. The control circuit may determine limits for control of the level of the electrical load based on the position of the user's finger at the time of the user actuation and the present control level of the electrical load (e.g., intensity, level of covering material, etc.). For example, the control circuit may determine an upper limit Y_{MAX} on the display of the mobile device that represents an upper bound for controlling the electrical load and/or a lower limit Y_{MIN} on the display of the mobile device that represents a lower bound for controlling the electrical load. The control circuit executing the control software may ignore gestures made by the user that are below the lower limit Y_{MIN} or above the upper limit Y_{MAX}. For example, if the upper limit Y_{MAX} is halfway between the top edge of the display and the bottom edge of the display, the control circuit executing the control software may ignore any gestures made by the user that are in the top half of the display.

At 414, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 404. The control procedure 400 may end at 416.

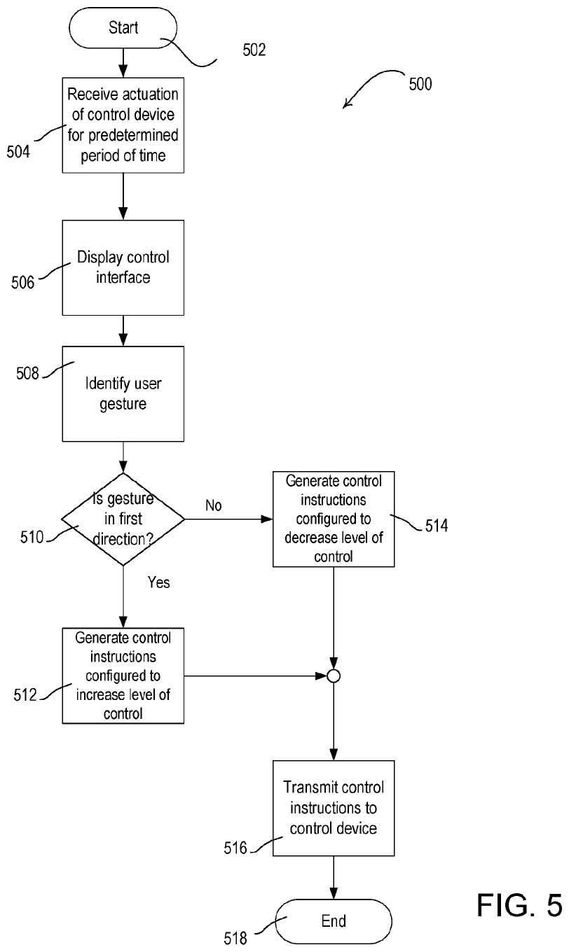

FIG. 5 is an example flowchart of a control procedure 500 for controlling the a control level of a load control device via user actuation of an icon on a display of a mobile device. The procedure 500 may be performed by the mobile device, such as the mobile device 200. For example, the mobile device may be a mobile device associated with a user. One or more portions of the procedure 500 may be stored in memory and executed as computer-readable instructions by one or more control circuits, such as the control circuit operating the control software on the mobile device. Though the procedure 500 may be described herein as being performed by a single device, such as a mobile device, the procedure 500 may be distributed across multiple devices.

The control procedure 500 may start at 502, for example, when the mobile device receives an actuation on the display. The control circuit of the mobile device may determine, at 504, that an actuation of an icon representing a control device has been received for a predetermined period of time. At 506, the control circuit may display a control interface. The control interface may indicate a relative level of control or a state of the load control device.

At 508, the control circuit may identify a user gesture that is performed after the actuation. The gesture may be performed in one or more given direction(s) on the display of the mobile device. The gesture may be performed while the actuation is maintained. The gestures may be monitored on an axis for determining a control level of an electrical load. For example, the control circuit may determine whether gestures are performed in an upward or downward direction on a vertical axis on the display of the mobile device.

At 510, the control circuit may determine whether the user has performed a gesture in a first direction on the display of the mobile device. For example, the first direction may be an upward direction. In another example, the first direction may be a direction on a horizontal axis. The control circuit may generate control instructions configured to increase a control level at 512, for example, if the gesture is in the first direction (e.g., upward or rightward upward direction) on the display of the mobile device. The control circuit may determine at 510 that the gesture is performed in a second direction. For example, the second direction may be an opposite direction to the first direction. The second direction may be a downward direction or leftward downward direction on the display of the mobile device. The control circuit may generate control instructions configured to decrease the control level at 514, for example, if the gesture is determined not to be in the first direction or is determined to be in the second direction.

Different types of control instructions may be generated based on the type of load control device and/or electrical load. For example, when the control device that is identified by the selection of the icon at 504 is a variable load control device, the control instructions may include a control level, such as an intensity level, a level of a covering material, a volume level, etc. The control level may be based on the distance of the gesture in the identified direction, as described herein. In another example, when the control device that is identified by the selection of the icon at 504 is a load control device capable of on/off control or absolute control of a state of an electrical load, the control instructions may be configured to switch the state of the electrical load in response to the detected direction. For example, the control instructions may be configured to turn the electrical load on in response to the detection of the gesture in the first direction and/or turn the electrical load off in response to the detection of the gesture in the second direction.

At 516, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 504. The control procedure 500 may end at 518.

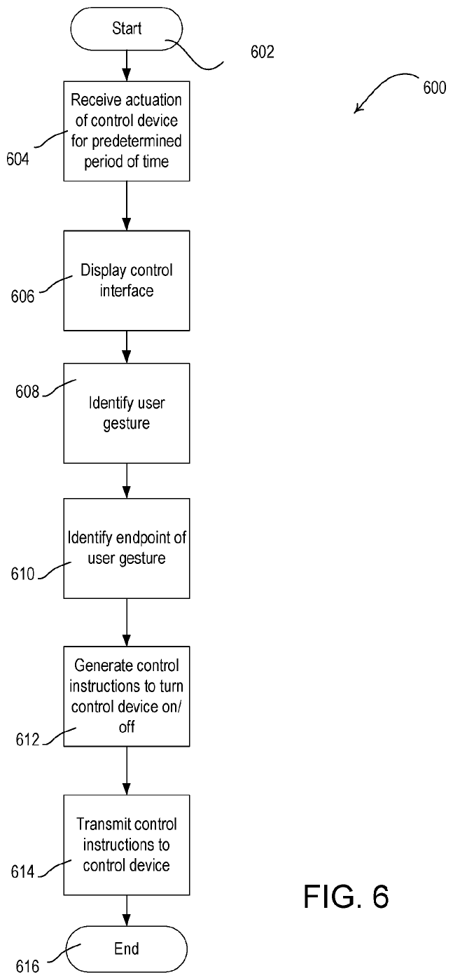

FIG. 6 is an example flowchart of a control procedure 600 for controlling the state of an electrical load being controlled by a load control device via user actuation of an icon on a display of a mobile device. The procedure 600 may be performed by the mobile device, such as the mobile device 200. For example, the mobile device may be a mobile device associated with a user. One or more portions of the procedure 600 may be stored in memory and executed as computer-readable instructions by one or more control circuits, such as the control circuit operating the control software on the mobile device. Though the procedure 600 may be described herein as being performed by a single device, such as a mobile device, the procedure 600 may be distributed across multiple devices.

The control procedure 600 may start at 602, for example, when the mobile device receives an actuation on the display. The control circuit of the mobile device may determine, at 604, that an actuation of an icon representing a control device has been received for a predetermined period of time. At 606, the control circuit may display a control interface. The control interface may indicate a relative level of control or a state of the load control device.

At 608, the control circuit may identify a user gesture. The gesture may be performed in a given direction. The gesture may be performed while the actuation is maintained on the display of the mobile device. At 610, the control circuit may identify an endpoint of the user gesture. For example, the user may perform a press and drag actuation on the icon identifying the control device at 604. The endpoint of the gesture may be located in one or more regions of the display of the mobile device that may be used for generating control instructions. For example, the control circuit may identify that the endpoint of the gesture is in a first region of the display of the mobile device and generate control instructions for turning an electrical load on. The control circuit may identify that the endpoint of the gesture is in a second region of the display of the mobile device and generate control instructions for turning an electrical load off. At 612, the control circuit generate may control instructions configured to change the state of the electrical load (e.g., turn the electrical load on or off) based on the region in which the endpoint of the gesture is located. Though an example is provided for turning an electrical load on/off based on the region in which an endpoint of a gesture is located, different types of load control may be performed by identifying an endpoint of a gesture in other regions of the display of a mobile device.

At 614, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 604. The control procedure 600 may end at 616.

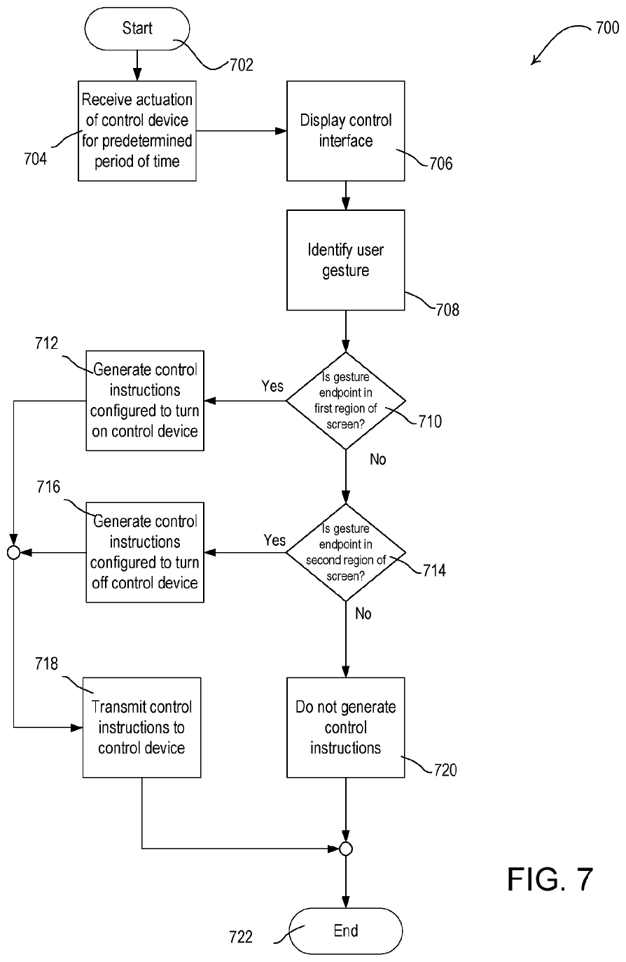

FIG. 7 is an example flowchart of a control procedure 700 for controlling the state of an electrical load being controlled by a load control device via user actuation of an icon on a display of a mobile device. The procedure 700 may be performed by the mobile device, such as the mobile device 200. For example, the mobile device may be a mobile device associated with a user. One or more portions of the procedure 700 may be stored in memory and executed as computer-readable instructions by one or more control circuits, such as the control circuit operating the control software on the mobile device. Though the procedure 700 may be described herein as being performed by a single device, such as a mobile device, the procedure 700 may be distributed across multiple devices.

The control procedure 700 may start at 702, for example, when the mobile device receives an actuation on the display. The control circuit of the mobile device may determine, at 704, that an actuation of an icon representing a control device has been received for a predetermined period of time. At 706, the control circuit may display a control interface. The control interface may indicate a relative level of control or a state of the load control device.

At 708, the control circuit may identify a user gesture. The user gesture may be performed in one or more given direction(s) on the display of the mobile device. The user gesture may be performed while the actuation is maintained. For example, the user gesture may be a press and drag gesture in a direction of one or more regions on the display of the mobile device.

The control circuit may determine whether an endpoint of the user gesture is in a first region or a second region of a display of a mobile device for generating different control instructions. At 710, the control circuit may determine whether the gesture endpoint is in the first region of the display. The control circuit may generate control instructions configured to turn on the control device at 712, for example, if the gesture endpoint is determined to be in the first region of the display. The control circuit may determine whether the gesture endpoint is in the second region of the display at 714. The control circuit may generate control instructions configured to turn off the control device at 716, for example, if the gesture endpoint is in the second region of the display. The control circuit may not generate control instructions at 720, for example, if the endpoint gesture is not in the first region of the screen or the second region of the screen.

The control circuit executing the control software may implement hysteresis such that the electrical load does not rapidly change between the on and off states if the user's finger is near a border between the first and second regions. For example, if the electrical load is in the on state at a given time, the control circuit executing the control software may expand the first region by moving the border between the first region and the second region in the direction of the second region by a predefined distance. If the user's finger moves into the second region (e.g., the electrical load enters the off state), the control circuit executing the control software may expand the second region by moving the border between the first region and the second region in the direction of the first region by a predefined distance.

At 718, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 704. The control procedure 700 may end at 722.

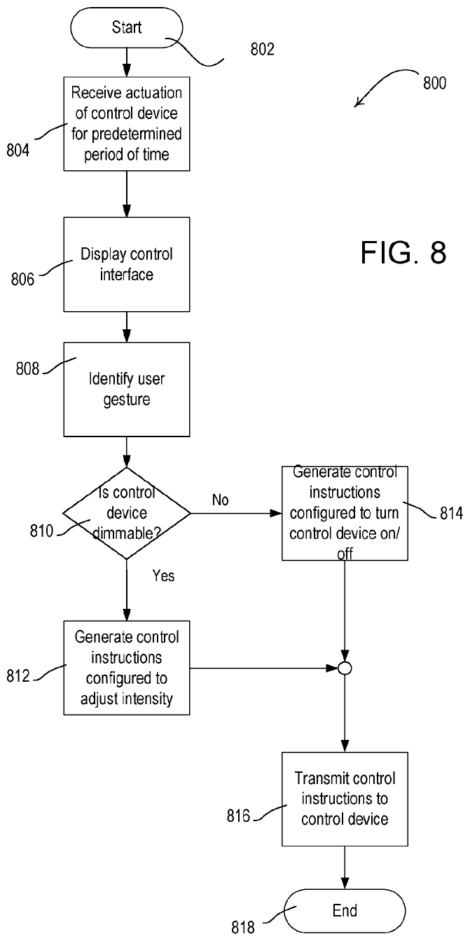

FIG. 8 is an example flowchart of a control procedure 800 for controlling a load control device via user actuation of an icon on a display of a mobile device. The procedure 800 may be performed by the mobile device, such as the mobile device 200. For example, the mobile device may be a mobile device associated with a user. One or more portions of the procedure 800 may be stored in memory and executed as computer-readable instructions by one or more control circuits, such as the control circuit operating the control software on the mobile device. Though the procedure 800 may be described herein as being performed by a single device, such as a mobile device, the procedure 800 may be distributed across multiple devices.

The control procedure 800 may start at 802, for example, when the mobile device receives an actuation on the display. The control circuit of the mobile device may determine, at 804, that an actuation of an icon representing a control device has been received for a predetermined period of time. At 806, the control circuit may display a control interface. The control interface may indicate a relative level of control or a state of the load control device.

At 808, the control circuit may identify a gesture from a user. The gesture may be performed while the actuation is maintained, such that the user may continue to perform control while the user's finger remains on the display of the mobile device. The control circuit may determine a type of control device that has been selected based on the actuation at 804 for generating control instructions based on the user gesture. For example, the control circuit may determine whether the control device is a variable load control device (e.g., configured for dimming control or other variable control) or an absolute load control device (e.g., configured for on/off control). At 810, the control circuit may determine that the selected control device is dimmable or configured for another form of variable load control. The control circuit may generate control instructions to control the type of electrical load being controlled and/or the type of load control device being controlled. For example, the control circuit may generate control instructions for variable load control when the selected control device is configured for variable load control and/or control instructions for absolute control (e.g., on/off control) when the selected control device is configured for absolute load control. The control circuit may generate control instructions configured to turn the control device on/off at 814, for example, if the control device is not determined to be dimmable or configured for another form of variable load control. The control circuit may generate control instructions configured to adjust the intensity or other level of control at 812, for example, if the control device is dimmable or configured for another form of variable load control.

At 816, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 804. The control procedure 800 may end at 818.

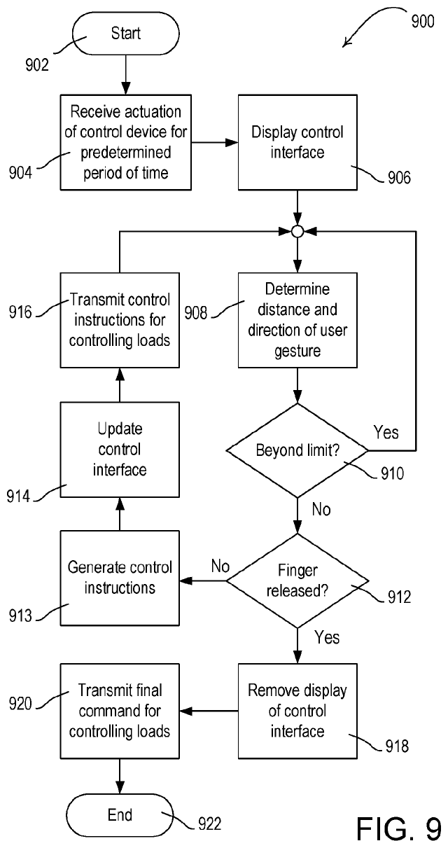

FIG. 9 is an example flowchart of a control procedure 900 for controlling the level of control of a load control device via user actuation of an icon on a display of a mobile device. The procedure 900 may be performed by the mobile device, such as the mobile device 200. For example, the mobile device may be a mobile device associated with a user. One or more portions of the procedure 900 may be stored in memory and executed as computer-readable instructions by one or more control circuits, such as the control circuit operating the control software on the mobile device. Though the procedure 900 may be described herein as being performed by a single device, such as a mobile device, the procedure 900 may be distributed across multiple devices.

The control procedure 900 may start at 902, for example, when the mobile device receives an actuation on the display. The control circuit of the mobile device may determine, at 904, that an actuation of an icon representing a control device has been received for a predetermined period of time. At 906, the control circuit may display a control interface. The control interface may indicate a relative level of control or a state of the load control device.

At 908, the control circuit may determine the distance and direction of a user gesture. At 910, the control circuit may determine whether the distance of the user's gesture is within a limit (e.g., upper or lower limit). The limit may be a predetermined limit or a calculated limit for the level of control of an electrical load. The level of control may be limited by a maximum position and/or a minimum position based on the present control level of the electrical load. For example, the position of the user's finger may be determined by the control circuit at the time of the user's actuation and control instructions may be transmitted as the user gestures between the maximum position and minimum position on the display of the mobile device.

The control circuit may determine limits for control of the level of the electrical load based on the position of the user's finger at the time of the user actuation and the present control level of the electrical load (e.g., intensity, level of covering material, etc.). For example, the control circuit may determine an upper limit Y_{MAX} on the display of the mobile device that represents an upper bound for controlling the electrical load and/or a lower limit Y_{MIN} on the display of the mobile device that represents a lower bound for controlling the electrical load. The upper limit and lower limit change depending on the present control level of the load control device, so as to efficiently utilize the size of the display. The control circuit executing the control software may ignore gestures made by the user that are below the lower limit Y_{MIN} or above the upper limit Y_{MAX}.

As the user continues to gesture within the one or more limits on the display of the mobile device, the control circuit may adjust the level of control of the one or more identified load control devices. For example, at 910 the control circuit of the mobile device may determine that an endpoint of the user's gesture is within the limit(s) for performing control. The control circuit may generate control instructions at 913 based on a change in the location of the endpoint of the user gesture within the defined limit(s) on the display of the mobile device. For example, the control circuit may generate control instructions at 913 after a predetermined period of time and/or a minimum distance of change of the user's gesture within the upper and lower limits, and so long as the actuation on the display of the mobile device is maintained. In an example, the control circuit may generate control instructions at 913 for changing the intensity level of a lighting load by a percentage based on the distance of change of the user's gesture within the upper and lower limits of the display. The control interface may be updated at 914 to reflect the change in the level of control of the control device based on the control instructions. At 916, the control circuit may transmit (e.g., via a communication circuit) the control instructions to the control device(s) for performing load control. For example, the control instructions may be transmitted in a message that includes an identifier of one or more load control devices identified by the actuation of the icon that was actuated at 904. Though the procedure 900 shows the control interface being updated at 914 prior to the transmission of the control instructions at 916, the control circuit may transmit the control instructions and update the control interface after the transmission of the control instructions and/or receipt of an acknowledgement or feedback message has been received.

If the distance of the user's gesture is determined to be beyond a limit at 910, then the control circuit may ignore gestures made by the user that are beyond the limit. For example, gestures that are made by the user that are below a lower limit or above an upper limit on the display of the mobile device may be ignored. When the user's gesture is detected at the limit, control instructions may be generated and transmitted to the control device. For example, the control circuit may determine that an upper limit Y_{MAX} on the display of the mobile device has been reached and generate control instructions for controlling the electrical load to a maximum value (e.g., 100% intensity, fully-open position of motorized window treatment, or another maximum value). The control circuit may determine that a lower limit Y_{MIN} on the display of the mobile device has been reached and generate control instructions for controlling the electrical load to a minimum value (e.g., 0% intensity, fully closed position of motorized window treatment, or another minimum value).

The control circuit may continue to control the electrical loads based on the user's gesture so long as the actuation of the user's finger on the display of the mobile device is maintained. The control circuit may monitor whether the user's finger has been released from the display of the mobile device at 912. If the user's finger is determined to be released from the display of the mobile device at 912, the control circuit may remove the display of control interface at 918. The control circuit may transmit one or more final command(s) for controlling the electrical loads at 920. For example, the control instructions may be transmitted in a message that includes an identifier of the one or more load control devices identified by the actuation of the icon that was actuated at 904. The control procedure 900 may end at 922.

In addition to what has been described herein, the methods and systems may also be implemented in a computer program(s), software, or firmware incorporated in one or more computer-readable media for execution by a computer(s) or processor(s), for example. Examples of computer-readable media include electronic signals (transmitted over wired or wireless connections) and tangible/non-transitory computer-readable storage media. Examples of tangible/non-transitory computer-readable storage media include, but are not limited to, a read only memory (ROM), a random-access memory (RAM), removable disks, and optical media such as CD-ROM disks, and digital versatile disks (DVDs).

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

What is claimed is:

1. A method comprising:
displaying an icon representing a load control device on a display of a mobile device, wherein a first type of actuation of the icon causes the mobile device to enter a first load control mode;
detecting a second type of actuation of the icon representing the load control device on the display of the mobile device;
while the actuation is maintained, entering a second load control mode configured to control an electrical load associated with the load control device;
detecting movement of the actuation in a direction in a first axis on the display of the mobile device;
in response to the detected movement of the actuation in the direction in the first axis on the display of the mobile device, determining a distance of the movement of the actuation in the direction in the first axis on the display of the mobile device;
generating control instructions to adjust a control level of the electrical load based on the distance of the actuation and the direction in the first axis; and
transmitting the control instructions to the load control device.

2. The method of claim 1, wherein the first type of actuation is a transitory actuation within a first period of time, and wherein the second type of actuation is maintained for greater than the first period of time.

3. The method of claim 1, wherein the first type of actuation is a single actuation within a first period of time, and wherein the second type of actuation includes multiple actuations.

4. The method of claim 1, wherein the first axis is a vertical axis, and wherein:
the direction in the first axis is an upward direction, and wherein the control instructions are configured to increase the control level of the electrical load by an amount based on a distance of the user's gesture in the upward direction; or
the direction in the first axis is a downward direction, and wherein the control instructions are configured to decrease the control level of the electrical load by an amount based on a distance of the user's gesture in the downward direction.

5. The method of claim 1, further comprising:
determining a position of the user's finger on the display of the mobile device;
determining the control level of the electrical load;
determining, based on the control level of the electrical load and the position of the user's finger on the display, at least one of an upper limit or a lower limit for limiting control of the electrical load based on gestures from the user; and
ignoring gestures made by the user on the display of the mobile device that are above the upper limit or below the lower limit.

6. The method of claim 1, wherein entering the second load control mode comprises displaying a first load control interface on the display of the mobile device.

7. The method of claim 1, further comprising displaying, on the display of the mobile device, an indication of the adjusted control level of the electrical load.

8. The method of claim 1, wherein the method is performed by the mobile device, and wherein the control instructions are transmitted to the load control device via a system controller.

9. The method of claim 1, wherein the icon representing the load control device indicates that the load control device is available for gesture control.

10. The method of claim 9, further comprising:
determining that the load control device is a device capable of gesture control, wherein the load control device is a first load control device, and wherein the icon is a first icon;
displaying a second icon representing a second load control device on the display of the mobile device;
detecting an actuation of the second icon representing the second load control device on the display of the mobile device;
determining that the second load control device is not available for gesture control; and
entering a third load control mode configured to control a second electrical load associated with the second load control device.

11. The method of claim 10, wherein the first load control device is determined to be available for gesture control based on the first load control device being configured for variable control, and wherein the second load control device is determined to not be available for gesture control based on the second load control device being configured for absolute control.

12. The method of claim 1, wherein the load control device is a lighting control device, and wherein adjusting the control level of the electrical load comprises adjusting a brightness of a lighting load controlled by the lighting control device.

13. The method of claim 1, wherein the load control device is a motorized window treatment, and wherein adjusting the control level of the electrical load comprises adjusting a shade position of the motorized window treatment.

14. The method of claim 1, wherein the load control device is a speaker, and wherein adjusting the control level of the electrical load comprises adjusting a volume of the speaker.

15. The method of claim 1, further comprising:
while the actuation is maintained, determining that the user gesture is being performed in a direction in a second axis, and
in response to the user gesture being identified in the direction in the second axis on the display of the mobile device, allowing the user to continue to gesture in the second direction in the second axis without generating control instructions in response to the movement in the direction in the second axis.

16. The method of claim 15, wherein the second axis is a horizontal axis.

17. The method of claim 1, further comprising displaying, in response to receiving the actuation of the icon for the predetermined period of time, a status bar indicating a present status of the electrical load.

18. The method of claim 1, further comprising:
determining that the actuation of the icon has discontinued;
exiting the second load control mode; and
ceasing to generate control instructions.

19. The method of claim 1, further comprising determining an amount by which to adjust the control level of the electrical load based on the distance of the user gesture in the first direction.

20. The method of claim 19, wherein determining the amount by which to adjust the control level of the electrical load comprises:
determining an initial position of the actuation;
determining a present control level of the control device;
determining a maximum position and a minimum position for the movement of the actuation; and
determining an adjusted position of the actuation relative to the minimum position and the maximum position.

21. The method of claim 20, further comprising disregarding any movement of the actuation below the minimum position or above the maximum position.

22. The method of claim 1, wherein the control instructions comprise first control instructions, wherein the mobile device is configured to display a control interface in a predefined location when operating in the first load control mode, wherein the control interface comprises an actuator configured to move along a slider slot or a button configured to generate control instructions to adjust the control level of the electrical load, the method further comprising:
detecting an actuation of the button or movement of the actuator along the slider slot on the display of the mobile device;
in response to the detected actuation of the button or movement of the actuator along the slider slot on the display of the mobile device, generating second control instructions to adjust the control level of the electrical load; and
transmitting the second control instructions to the load control device.

23. The method of claim 22, further comprising:
detecting a third type of actuation of the icon representing the load control device on the display of the mobile device;
in response to the detection of the third type of actuation, entering a third load control mode configured to control the electrical load associated with the load control device;
detecting user input within a region of a plurality of regions on the display of the mobile device;
in response to the detected user input within the region, generating third control instructions to adjust the control level of the electrical load based on the region of the plurality of regions; and
transmitting the third control instructions to the load control device.

24-48. (canceled)
